(19) United States
(12) Patent Application Publication
(10) Pub. No.: US 2026/0164212 A1
(43) Pub. Date: Jun. 11, 2026

(54) ACOUSTIC PROCESSING DEVICE AND ACOUSTIC PROCESSING METHOD

(71) Applicant: Panasonic Intellectual Property Corporation of America, Torrance, CA (US)

(72) Inventors: Kota NAKAHASHI, Osaka (JP); Tomokazu Ishikawa, Osaka (JP); Hikaru Usami, Osaka (JP); Seigo Enomoto, Kyoto (JP); Hiroyuki Ehara, Kanagawa (JP); Mariko Yamada, Hyogo (JP); Shuji Miyasaka, Osaka (JP)

(21) Appl. No.: 19/180,571

(22) Filed: Apr. 16, 2025

Related U.S. Application Data
(63) Continuation of application No. PCT/JP2023/036494, filed on Oct. 6, 2023.
(60) Provisional application No. 63/417,410, filed on Oct. 19, 2022.

(30) Foreign Application Priority Data
Jul. 5, 2023 (JP) 2023-110710

(51) Int. Cl. H04S 7/00

(52) U.S. Cl. CPC H04S 7/305; H04S 7/303; H04S 2400/11; H04S 2420/01

(57) ABSTRACT

An acoustic processing device includes: a circuit; and a memory, wherein using the memory, the circuit: obtains sound space information, the sound space information including information on a sound source in a sound space, information on an object in the sound space, and information on a position of a listener in the sound space; and calculates, using the sound space information, an evaluation value of a reflected sound generated in response to a sound generated from the sound source.

### CROSS REFERENCE TO RELATED APPLICATIONS

This is a continuation application of PCT International Application No. PCT/JP2023/036494 filed on Oct. 6, 2023, designating the United States of America, which is based on and claims priority of U.S. Provisional Patent Application No. 63/417,410 filed on Oct. 19, 2022, and Japanese Patent Application No. 2023-110710 filed on Jul. 5, 2023. The entire disclosures of the above-identified applications, including the specifications, drawings and claims are incorporated herein by reference in their entirety.

### FIELD

The present disclosure relates to an acoustic processing device and the like.

### BACKGROUND

In recent years, the spread of products and services that utilize extended reality (ER) (may be also expressed as “XR”) including virtual reality (VR), augmented reality (AR), and mixed reality (MR) has advanced. Accompanying this, there has been growing demand for acoustic processing technologies that provide listeners with immersive audio that, in a virtual space or a real-world space, assigns acoustic effects that are generated in accordance with the environment of the space to sounds emitted from a virtual sound source.

Note that “listener” can also be expressed as “user”. Furthermore, Patent Literature (PTL) 1, PTL 2, PTL 3, and Non Patent Literature (NPL) 1 disclose techniques that relate to the acoustic processing device and the acoustic processing method of the present disclosure.

### CITATION LIST

### Patent Literature

PTL 1: Japanese Patent No. 6288100
PTL 2: Japanese Unexamined Patent Application Publication No. 2019-22049
PTL 3: WO Publication No. 2021/180938

### Non Patent Literature

NPL 1: Appl. Sci. 2019, 9, 2854; doi: 10.3390/app9142854 “Psychoacoustic Models for Perceptual Audio Coding—A Tutorial Review”

### SUMMARY

### Technical Problem

For example, PTL 1 discloses a technique that applies signal processing to an object audio signal for presentation to a listener. Accompanying the spread of ER technologies and the diversification of services that use ER technologies, there is a demand for acoustic processing that is adapted to differences in, for example, the acoustic quality required for services, the signal processing capabilities of the terminals to be used, and the sound quality that can be produced in sound-presenting devices. Furthermore, providing this requires further improvements in acoustic processing techniques.

Here, the improvement of acoustic processing techniques refers to changing existing acoustic processing. For example, the improvement of acoustic processing techniques provides processing that assigns new acoustic effects, a reduction in the amount of processing performed for acoustic processing, an improvement in the audio quality obtained by acoustic processing, a reduction in the amount of data for information used in performing acoustic processing, simplification of the acquisition or generation of information used in performing acoustic processing, or the like. Alternatively, the improvement of acoustic processing techniques may provide any combination of two or more of these.

In particular, these improvements are required in apparatuses and services that enable a listener to freely move within a virtual space. However, the above-described effects that can be obtained by improvements in acoustic processing techniques are merely examples. One or more aspects understood based on the present disclosure may be an aspect arrived at based on a viewpoint that is different from that described above, an aspect that achieves an object that is different from that described above, or an aspect that enables obtaining an effect that is different from those described above.

### Solution to Problem

An acoustic processing device according to one aspect understood based on the present disclosure includes: a circuit; and a memory, wherein using the memory, the circuit: obtains sound space information, the sound space information including information on a sound source in a sound space, information on an object in the sound space, and information on a position of a listener in the sound space; and calculates, using the sound space information, an evaluation value of a reflected sound generated in response to a sound generated from the sound source.

Note that these comprehensive or specific aspects may be implemented as a system, a device, a method, an integrated circuit, a computer program, or a non-transitory computer-readable recording medium such as a CD-ROM, or may be implemented as any combination of these.

### Advantageous Effects

For example, one aspect of the present disclosure may make it possible to provide processing that assigns new acoustic effects, a reduction in the amount of processing performed for acoustic processing, an improvement in the audio quality obtained by acoustic processing, a reduction in the amount of data for information used in performing acoustic processing, simplification of the acquisition or generation of information used in performing acoustic processing, or the like. Alternatively, one aspect of the present disclosure may make it possible to provide any combination of these. Consequently, one aspect of the present disclosure enables contributing to improving the acoustic experience of a listener by providing acoustic processing adapted to the listener's usage environment.

In particular, the above-described effects can be obtained in apparatuses and services that allow a listener to freely move within a virtual space. However, the above-described effects are merely examples of the effects of various aspects that are understood based on the present disclosure. Each of one or more aspects identified based on the present disclosure may be an aspect arrived at based on a viewpoint that is different from that described above, an aspect that achieves an object that is different from that described above, or an aspect that enables an effect different from those described above to be obtained.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for explaining a first example of a direct sound and reflected sounds generated in a sound space.

FIG. 2 is a diagram for illustrating a three-dimensional sound reproduction system according to an embodiment.

FIG. 3A is a block diagram for illustrating a configuration example of an encoding device according to an embodiment.

FIG. 3B is a block diagram for illustrating a configuration example of a decoding device according to an embodiment.

FIG. 3C is a block diagram for illustrating another configuration example of an encoding device according to an embodiment.

FIG. 3D is a block diagram for illustrating another configuration example of a decoding device according to an embodiment.

FIG. 4A is a block diagram for illustrating a configuration example of a decoder according to an embodiment.

FIG. 4B is a block diagram for illustrating another configuration example of a decoder according to an embodiment.

FIG. 5 is a diagram for illustrating an example of a physical configuration of an audio signal processing device according to an embodiment.

FIG. 6 is a diagram for illustrating an example of a physical configuration of an encoding device according to an embodiment.

FIG. 7 is a block diagram for illustrating a configuration example of a renderer according to an embodiment.

FIG. 8 is a flowchart for illustrating an operation example of an audio signal processing device according to an embodiment.

FIG. 9 is a diagram for illustrating a comparatively distant positional relationship between a listener and an obstacle object.

FIG. 10 is a diagram for illustrating a comparatively close positional relationship between a listener and an obstacle object.

FIG. 11 is a flowchart for illustrating an example of selection processing according to an embodiment.

FIG. 12 is a flowchart for illustrating an example of evaluation processing according to an embodiment.

FIG. 13 is a diagram for illustrating an example of the arrival angle between a direct sound and a reflected sound.

FIG. 14 is a diagram for illustrating an example of a method for setting threshold value data based on the temporal masking phenomenon.

FIG. 15 is a diagram for illustrating an example of threshold value data.

FIG. 16 is a diagram for illustrating relationships between time differences between direct sounds and reflected sounds, and threshold values.

FIG. 17 is a diagram for illustrating a configuration example for a renderer to perform pipeline processing.

### DESCRIPTION OF EMBODIMENTS

### Underlying Knowledge Forming Basis of the Present Disclosure

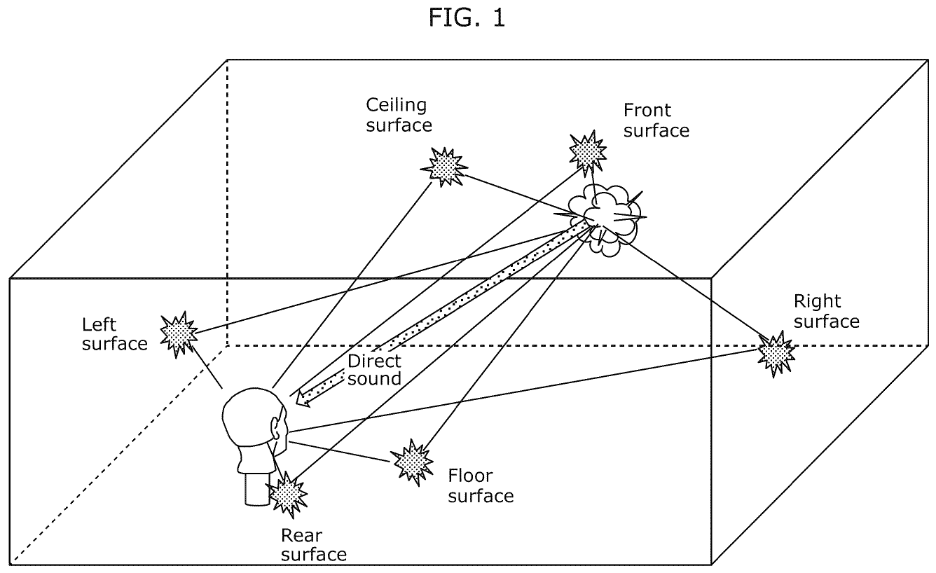

FIG. 1 is a diagram for illustrating a first example of a direct sound and reflected sound generated in a sound space. In acoustic processing in which characteristics of a virtual space are expressed by a sound, it is effective to reproduce not only direct sounds, but also reflected sounds in order to express the size of the space, the material of the walls, and the like, as well as to allow for accurately grasping the location of the sound source (the positioning of the sound image).

For example, when a sound is heard in a rectangular parallelepiped room such as that in FIG. 1, six primary reflected sounds, corresponding to the six walls, are generated for one sound source. Reproducing these reflected sounds provides a clue for appropriate understanding of the space and the sound image. Furthermore, for each reflected sound, a secondary reflected sound is generated by a surface other than the reflection surface that generated that reflected sound. These reflected sounds are also effective sensory clues.

However, even when consideration is given no further than to secondary reflection, one direct sound and 36 (6+6×5) reflected sounds are generated for one sound source. Thus, 37 sound rays are generated, and processing these sound rays requires a significant amount of computation.

Furthermore, in applied products in recent years for which metaverses are imagined, such as virtual meetings, virtual shopping, virtual concerts, and the like, a plurality of sound sources are present out of necessity, whereby an even greater amount of computation is required.

Moreover, the listener hearing the sounds in a virtual space uses headphones or VR goggles. In order to provide three-dimensional sound to such a listener, binaural processing that assigns a sound pressure ratio and a phase difference between the two ears and reproduces the direction of arrival and distance sensation of the sounds is performed on each sound ray. Thus, if an attempt were made to reproduce every reflected sound that is generated, the amount of computation would become immense.

On the other hand, in light of convenience, a small storage battery is sometimes used as the battery for the VR goggles worn by the listener who experiences the virtual space. Lessening the computational load resulting from the above-described processing makes it possible to further extend the life of the storage battery. To this end, the number of sound rays, which are emitted on a scale of hundreds, is desirably reduced, within a scope at which grasping the space and the positioning of the sounds is not harmed.

Furthermore, in a system that reproduces acoustics, a degree of freedom such as 6DoF (6 degrees of freedom) or the like may be allowed with respect to the position and orientation of the listener. In this case, the positional relationship between the listener, the sound sources, and the objects that reflect sounds cannot be fixed until the time of reproduction (the time of rendering). For this reason, the reflected sounds as well cannot be fixed until the time of reproduction. Thus, it is difficult to determine the reflected sounds to be processed beforehand.

In other words, the number of sound rays for reproducing the characteristics of a virtual space with sound and the transition of the sound volume of the sound of each sound ray are calculated at the time of rendering. Thus, reduction of the amount of computation during rendering is not easy.

As a method for reducing the number of sound rays in a space, for example, PTL 1 discloses a method in which levels of importance of audio objects are detected, and sounds originating from audio objects having low levels of importance are not reproduced.

However, when a level of freedom such as 6DoF is allowed with respect to the position and orientation of the listener, based on the direct sounds generated from the sound sources and the reflected sounds generated by the direct sound being reflected by objects, the listener grasps the positional relationship between the listener, the sound sources, and the objects that reflect sounds. Thus, when a direct sound and reflected sounds originating from a specific sound source are reduced, it may be difficult to accurately grasp the space and the positioning of sounds.

Accordingly, the present disclosure has the object of providing an acoustic processing device and the like that enable reducing the computational load for processing reflected sounds, while making it possible to grasp the space and the positioning of sounds.

### Overview of Disclosure

An acoustic processing device according to a first aspect understood based on the present disclosure includes: a circuit; and a memory, wherein using the memory, the circuit: obtains sound space information, the sound space information including information on a sound source in a sound space, information on an object in the sound space, and information on a position of a listener in the sound space; and calculates, using the sound space information, an evaluation value of a reflected sound generated in response to a sound generated from the sound source.

Using the sound space information, the device according to the above-described aspect is able to appropriately calculate the evaluation value of a reflected sound that depends on information on the sound source, information on the object, and information on the position of the listener. Thus, reflected sounds to be processed can be appropriately selected based on the evaluation values of reflected sounds. Therefore, the computational load for the reflected sounds can be reduced while making it possible to grasp the space and the positioning of sounds.

An acoustic processing device according to a second aspect understood based on the present disclosure is the acoustic processing device according to the first aspect, in which the circuit may control whether to select the reflected sound, based on the evaluation value.

The device according to the above-described aspect is able to appropriately select reflected sounds to be processed, based on the evaluation values of reflected sounds.

An acoustic processing device according to a third aspect understood based on the present disclosure is the acoustic processing device according to the second aspect, in which when the reflected sound is not selected, the circuit may skip binaural processing on the reflected sound.

By skipping the binaural processing, the device according to the above-described aspect is able to reduce the computational load for the reflected sounds.

An acoustic processing device according to a fourth aspect understood based on the present disclosure is the acoustic processing device according to any one of the first to third aspects, in which the circuit may: calculate a sound volume of the reflected sound; and calculate the evaluation value when the sound volume exceeds a predetermined threshold value.

When the sound volume of the reflected sound is less than or equal to the predetermined threshold value, the device according to the above-described aspect is able to omit calculation of the evaluation value of the reflected sound. Therefore, the device according to the above-described aspect is able to reduce the computational load for the reflected sounds.

An acoustic processing device according to a fifth aspect understood based on the present disclosure is the acoustic processing device according to the second aspect, in which when the reflected sound is selected based on the evaluation value, the circuit may: calculate a total computational load of one or more selected reflected sounds including the reflected sound; and skip selecting the reflected sound when the total computational load exceeds a predetermined upper limit.

The device according to the above-described aspect is able to inhibit the total computational load from exceeding the predetermined upper limit. In this way, the device according to the above-described aspect is able to reduce the computational load for the reflected sounds.

An acoustic processing device according to a sixth aspect understood based on the present disclosure is the acoustic processing device according to the fifth aspect, in which the total computational load may be specified by a total number of the one or more selected reflected sounds or by an amount of processing required for the one or more selected reflected sounds.

The device according to the above-described aspect is able to inhibit the total number of the one or more selected reflected sounds or the amount of processing required for the one or more selected reflected sounds from exceeding the predetermined upper limit. In this way, the device according to the above-described aspect is able to reduce the computational load for the reflected sounds.

An acoustic processing device according to a seventh aspect understood based on the present disclosure is the acoustic processing device according to any one of the first to sixth aspects, in which the circuit may: calculate, for each of a plurality of reflected sounds generated as the reflected sound in the sound space, a sound volume of the reflected sound; and calculate, for each of one or more reflected sounds of the plurality of reflected sounds that has a sound volume greater than or equal to a predetermined threshold value, the evaluation value of the reflected sound.

When, for each of the plurality of reflected sounds, the sound volume of the reflected sound is less than the threshold value, the device according to the above-described aspect is able to omit calculation of the evaluation value of the reflected sound. Therefore, the device according to the above-described aspect is able to reduce the computational load for the reflected sounds.

An acoustic processing device according to an eighth aspect understood based on the present disclosure is the acoustic processing device according to the seventh aspect, in which the circuit may: calculate a total computational load of the one or more reflected sounds; and calculate, for each of the one or more reflected sounds, the evaluation value of the reflected sound, when the total computational load exceeds a predetermined upper limit.

When the total computational load is less than or equal to the predetermined upper limit, the device according to the above-described aspect is able to omit calculation of the evaluation value of the reflected sounds. Therefore, the device according to the above-described aspect is able to reduce the computational load for the reflected sounds.

An acoustic processing device according to a ninth aspect understood based on the present disclosure is the acoustic processing device according to any one of the first to eighth aspects, in which the circuit may: calculate, for each of a plurality of reflected sounds generated as the reflected sound in the sound space, the evaluation value of the reflected sound; add, for each of the plurality of reflected sounds in descending order of the evaluation value, a computational load of the reflected sound to a total computational load; compare the total computational load to a predetermined upper limit each time the computational load of the reflected sound is added to the total computational load; select the reflected sound when the total computational load obtained by adding the computational load of the reflected sound does not exceed the predetermined upper limit; and skip selecting remaining one or more reflected sounds among the plurality of reflected sounds when the total computational load obtained by adding the computational load of the reflected sound exceeds the predetermined upper limit, the remaining one or more reflected sounds being the reflected sound and after.

When the total computational load resulting from adding the computational loads in order exceeds the predetermined upper limit, the device according to the above-described aspect is able to exclude the remaining reflected sounds from selection. Thus, the device according to the above-described aspect is able to limit the reflected sounds to be processed, thereby reducing the computational load.

An acoustic processing device according to a tenth aspect understood based on the present disclosure is the acoustic processing device according to any one of the first to ninth aspects, in which the evaluation value may be a total value of one or more indicator values among an indicator value regarding sound volume, a visual indicator value, an indicator value regarding the object, and an indicator value indicating a relationship between a direct sound corresponding to the reflected sound and the reflected sound.

The device according to the above-described aspect is able to calculate the total value of the one or more indicator values, among the indicator value regarding sound volume, the visual indicator value, the indicator value regarding the object, and the indicator value indicating the relationship between the direct sound and the reflected sound, as the evaluation value. Therefore, it is possible to appropriately select the reflected sounds to be processed, based on the indicator value regarding sound volume, the visual indicator value, the indicator value regarding the object, or the indicator value indicating the relationship between the direct sound and the reflected sound.

An acoustic processing device according to an eleventh aspect understood based on the present disclosure is the acoustic processing device according to the tenth aspect, in which the circuit may set the indicator value regarding sound volume to be greater as a sound volume of the sound generated from the sound source is greater.

The device according to the above-described aspect is able to calculate a higher evaluation value as the sound volume of the sound generated from the sound source is greater. Thus, reflected sounds to be processed can be appropriately selected based on evaluation values that are higher as the sound volume of the sound generated from the sound source is greater.

An acoustic processing device according to a twelfth aspect understood based on the present disclosure is the acoustic processing device according to the tenth or eleventh aspect, in which when the sound source is in a visual field of the listener, the circuit may increase the visual indicator value to be greater than when the sound source is not in the visual field of the listener.

The device according to the above-described aspect is able to calculate evaluation values that are higher when the sound source is in the visual field than when the sound source is not in the visual field. Thus, it is possible to appropriately select reflected sounds to be processed based on evaluation values that are higher when the sound source is in the visual field than when the sound source is not in the visual field.

An acoustic processing device according to a thirteenth aspect understood based on the present disclosure is the acoustic processing device according to any one of the tenth to twelfth aspects, in which the circuit may set the visual indicator value to be greater as a moving speed of the sound source is slower.

The device according to the above-described aspect is able to calculate evaluation values that are higher as the movement speed of the sound source is slower. Thus, reflected sounds to be processed can be appropriately selected based on evaluation values that are higher as the movement speed of the sound source is slower.

An acoustic processing device according to a fourteenth aspect understood based on the present disclosure is the acoustic processing device according to any one of the tenth to thirteenth aspects, in which the indicator value regarding the object may be assigned per object in the sound space and may be included in the sound space information.

The device according to the above-described aspect is able to calculate evaluation values based on indicator values that are assigned to each object. Thus, reflected sounds to be processed can be appropriately selected based on the indicator values that are assigned to each object.

An acoustic processing device according to a fifteenth aspect understood based on the present disclosure is the acoustic processing device according to any one of the tenth to fourteenth aspects, in which the circuit may set the indicator value indicating the relationship between the direct sound and the reflected sound to be greater as an angle formed by a direction of arrival of the direct sound and a direction of arrival of the reflected sound is larger.

The device according to the above-described aspect is able to calculate evaluation values that are higher as the angle formed by the direction of arrival of the direct sound and the direction of arrival of the reflected sound is larger. Thus, reflected sounds to be processed can be appropriately selected based on evaluation values that are higher as the angle formed by the direction of arrival of the direct sound and the direction of arrival of the reflected sound is larger.

An acoustic processing device according to a sixteenth aspect understood based on the present disclosure is the acoustic processing device according to any one of the tenth to fifteenth aspects, in which the circuit may set the indicator value indicating the relationship between the direct sound and the reflected sound to be greater as a difference between a distance the direct sound travels from the sound source to arrive at the listener and a distance the reflected sound travels from the sound source to arrive at the listener after being reflected is greater.

The device according to the above-described aspect is able to calculate evaluation values that are higher as the difference between the distance to the direct sound and the distance to the reflected sound is greater. Thus, reflected sounds to be processed can be appropriately selected based on evaluation values that are higher as the difference between the distance to the direct sound and the distance to the reflected sound is greater.

An acoustic processing device according to a seventeenth aspect understood based on the present disclosure is the acoustic processing device according to any one of the tenth to sixteenth aspects, in which the circuit may set the indicator value indicating the relationship between the direct sound and the reflected sound to be greater as an amplitude value of the reflected sound further exceeds a temporal masking threshold value, the temporal masking threshold value being a threshold value of a temporal masking phenomenon in which the reflected sound is masked by the direct sound when the amplitude value of the reflected sound is less than or equal to the threshold value.

The device according to the above-described aspect is able to calculate evaluation values that are higher as the amplitude value of the reflected sound further exceeds the temporal masking threshold value. Thus, reflected sounds to be processed can be appropriately selected based on evaluation values that are higher as the amplitude value of the reflected sound further exceeds the temporal masking threshold value.

An acoustic processing device according to an eighteenth aspect understood based on the present disclosure is the acoustic processing device according to any one of the tenth to seventeenth aspects, in which the circuit may: repeat processing that includes: reducing the indicator value regarding the object regarding a reflected sound that has been selected from a plurality of reflected sounds each generated as the reflected sound in the sound space; calculating the evaluation value for each of the plurality of reflected sounds that have not been selected; and selecting, in descending order of the evaluation value, a reflected sound from the plurality of reflected sounds that have not been selected; and end the processing that is repeated, when a total computational load of one or more reflected sounds selected from the plurality of reflected sounds exceeds a predetermined upper limit.

When the total computational load of the one or more reflected sounds selected exceeds the predetermined upper limit, the device according to the above-described aspect is able to end the process of newly selecting reflected sounds. Thus, the device according to the above-described aspect is able to limit the reflected sounds to be processed, and is thereby able to reduce the computational load.

An acoustic processing device according to a nineteenth aspect understood based on the present disclosure includes: a circuit; and a memory, wherein using the memory, the circuit: obtains information on a sound volume of a sound outputted from a sound source; corrects an evaluation value of a reflected sound corresponding to the sound, by using information on the sound volume; and controls whether to select the reflected sound, based on the evaluation value corrected.

The device according to the above-described aspect is able to appropriately correct the evaluation values of reflected sounds that correspond to a sound by using information on the sound volume of the sound, and is thereby able to appropriately control the selection of reflected sounds.

An acoustic processing device according to a twentieth aspect understood based on the present disclosure is the acoustic processing device according to the nineteenth aspect, in which the sound volume may have a transition.

The device according to the above-described aspect is able to appropriately correct the evaluation values of reflected sounds that correspond to a sound by using information on sound volume that transitions, and is thereby able to appropriately control the selection of reflected sounds.

An acoustic processing method according to a twenty-first aspect understood based on the present disclosure includes: obtaining sound space information, the sound space information including information on a sound source in a sound space, information on an object in the sound space, and information on a position of a listener in the sound space; and calculating, using the sound space information, an evaluation value of a reflected sound generated in response to a sound generated from the sound source.

The method according to the above-described aspect can achieve similar effects to those of the acoustic processing device according to the first aspect.

A program according to a twenty-second aspect understood based on the present disclosure is a program for causing a computer to execute the acoustic processing method according to the twenty-first aspect.

The program according to the above-described aspect can, by using a computer, achieve similar effects to those of the acoustic processing method according to the twenty-first aspect.

Note that these comprehensive or specific aspects may be implemented as a system, a device, a method, an integrated circuit, a computer program, or a computer-readable recording medium such as a CD-ROM, or may be implemented as any combination of a system, a device, a method, an integrated circuit, a computer program, or a recording medium.

Hereinafter, an acoustic processing device, an encoding device, a decoding device, and a three-dimensional sound reproduction system according to the present disclosure will be described in detail with reference to the drawings. The three-dimensional sound reproduction system may be expressed as an audio signal reproduction system.

Note that all of the embodiments described hereinafter illustrate comprehensive or specific examples. The numerical values, shapes, materials, constituent elements, the arrangement and connection of the constituent elements, steps, the processing order of the steps, etc., shown in the following embodiments are mere examples, and thus are not intended to limit the aspects that are understood based on the present disclosure. Furthermore, among the constituent elements described in the following embodiments, constituent elements not included in specific aspects described in the present disclosure and constituent elements not recited in any one of the independent claims that indicate the broadest concepts are described as optional constituent elements.

### Embodiments

### Example of Three-Dimensional Sound Reproduction System

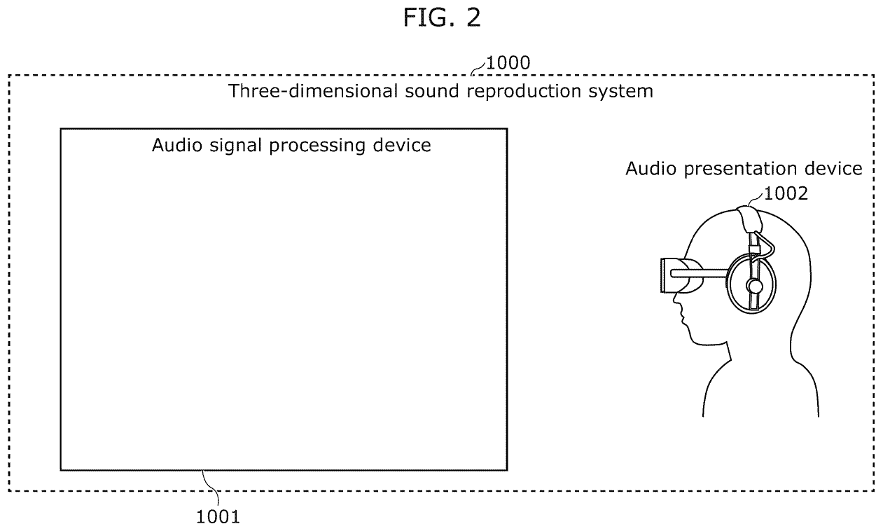

FIG. 2 is a diagram for illustrating an example of a three-dimensional sound reproduction system. Specifically, FIG. 2 illustrates three-dimensional sound reproduction system 1000, which is an example of a system to which acoustic processing or decoding processing of the present disclosure can be applied. Three-dimensional sound is also expressed as immersive audio. Three-dimensional sound reproduction system 1000 includes audio signal processing device 1001 and audio presentation device 1002.

Audio signal processing device 1001, which is also expressed as an acoustic processing device, applies acoustic processing to an audio signal emitted from a virtual sound source and generates an acoustic-processed audio signal to be presented to the listener. The audio signal is not limited to voices, and is acceptable as long as it is an audible sound. Acoustic processing is, for example, signal processing applied to an audio signal in order to reproduce one or more effects that a sound receives between when the sound is emitted from a sound source and when the sound arrives at the listener.

Audio signal processing device 1001 performs acoustic processing based on spatial information that describes the main factors for bringing about the above-described effects. Spatial information encompasses, for example: information that indicates the location of a sound source, a listener, and objects in the vicinity; information that indicates the shape of a space; parameters regarding sound propagation; and the like. Audio signal processing device 1001 is, for example, a PC (personal computer), a smartphone, a tablet, a game console, or the like.

An acoustic-processed signal is presented from audio presentation device 1002 to the listener. Audio presentation device 1002 is connected to audio signal processing device 1001 via wireless or wired communication. The acoustic-processed audio signal generated by audio signal processing device 1001 is transmitted to audio presentation device 1002 via wireless or wired communication.

When audio presentation device 1002 includes a plurality of devices such as, for example, a device for the right ear and a device for the left ear, or the like, the plurality of devices present sound in synchronization by means of communication between the plurality of devices or communication between each of the plurality of devices and audio signal processing device 1001. Audio presentation device 1002 is, for example, headphones, earphones, or a head-mounted display worn on the head of the listener, surround speakers including a plurality of fixed speakers, or the like.

Note that three-dimensional sound reproduction system 1000 may be used in combination with an image presentation device or a stereoscopic image presentation device that visually provides an ER experience that includes AR/VR. For example, a space handled by spatial information is a virtual space in which the positions of sound sources, the listener, and objects in the space are virtual positions of virtual sound sources, a virtual listener, and virtual objects in a virtual space. The space can also be expressed as a sound space. Furthermore, the spatial information can also be expressed as sound space information.

Furthermore, FIG. 2 illustrates a system configuration example in which audio signal processing device 1001 and audio presentation device 1002 are separate devices, but three-dimensional sound reproduction system 1000 to which the acoustic processing method or the decoding method of the present disclosure can be applied is not limited to the configuration in FIG. 2. For example, audio signal processing device 1001 may be included in audio presentation device 1002, and audio presentation device 1002 may perform both acoustic processing and sound presentation.

Furthermore, audio signal processing device 1001 and audio presentation device 1002 may, in a shared manner, perform the acoustic processing described in the present disclosure. Furthermore, a server connected to audio signal processing device 1001 or audio presentation device 1002 over a network may perform a part or all of the acoustic processing described in the present disclosure.

Furthermore, audio signal processing device 1001 may perform the acoustic processing by decoding a bitstream that has been generated by encoding at least a part of data of the audio signal and the spatial information used in the acoustic processing. Thus, audio signal processing device 1001 may be expressed as a decoding device.

### Example of Encoding Device

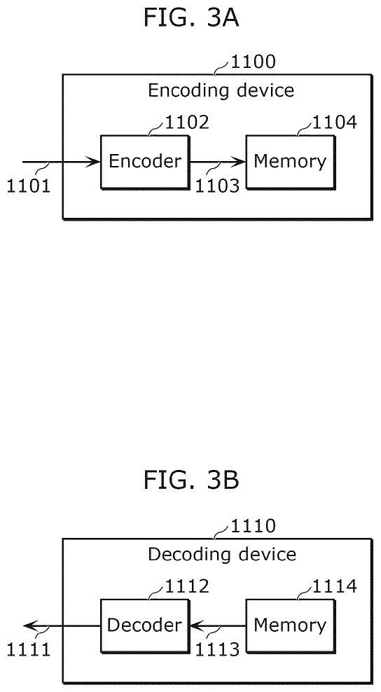

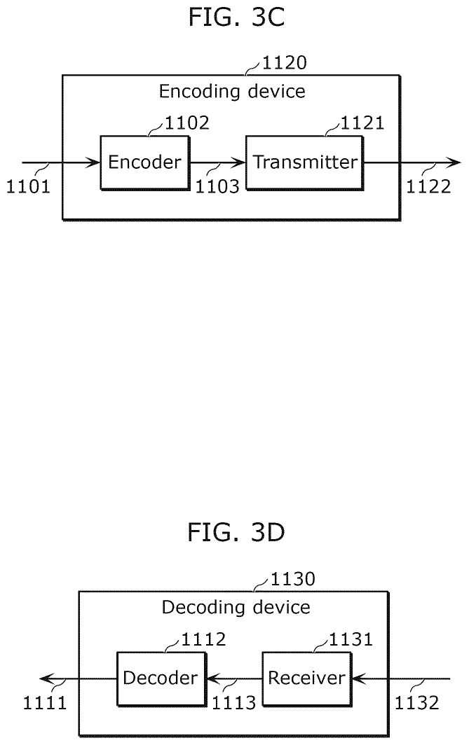

FIG. 3A is a block diagram for illustrating a configuration example of an encoding device. Specifically, FIG. 3A illustrates the configuration of encoding device 1100, which is an example of the encoding device of the present disclosure.

Input data 1101 is data to be encoded, and includes spatial information and/or an audio signal to be inputted into encoder 1102. Details regarding the spatial information will be described later.

Encoder 1102 encodes input data 1101 to generate encoded data 1103. Encoded data 1103 is, for example, a bitstream generated by means of encoding processing.

Memory 1104 stores encoded data 1103. Memory 1104 may be, for example, a hard disk or an SSD (solid-state drive), or may be another type of memory.

Note that in the above description, a bitstream generated by means of encoding processing was given as an example of encoded data 1103 stored in memory 1104, but encoded data 1103 may be data other than a bitstream. For example, encoding device 1100 may store, in memory 1104, converted data generated by converting the bitstream into a predetermined data format. The converted data may be, for example, a file or multiplexed stream that corresponds to one or more bitstreams.

Here, the file is a file having a file format of, for example, ISO base media file format (ISOBMFF) or the like. Furthermore, encoded data 1103 may be in the form of a plurality of packets generated by splitting the above-described bitstream or file.

For example, the bitstream generated by encoder 1102 may be converted to data that is different from the bitstream. In this case, encoding device 1100 may include a converter, not illustrated, and the converter may perform conversion processing, or conversion processing may be performed by a central processing unit (CPU) that is an example of a processor, described later.

### Example of Decoding Device

FIG. 3B is a block diagram for illustrating a configuration example of a decoding device. Specifically, FIG. 3B illustrates the configuration of decoding device 1110, which is an example of the decoding device of the present disclosure.

Memory 1114 stores, for example, the same data as encoded data 1103 generated by encoding device 1100. The stored data is read from memory 1114 and inputted into decoder 1112 as input data 1113. Input data 1113 is, for example, a bitstream that is to be decoded. Memory 1114 may be, for example, a hard disk or an SSD, or may be another type of memory.

Note that decoding device 1110 may not directly input data read from memory 1114 as input data 1113, and may instead convert the data read and then input the converted data into decoder 1112 as input data 1113. The data before conversion may be, for example, multiplexed data that includes one or more bitstreams. Here, the multiplexed data may be, for example, a file having a file format such as ISOBMFF or the like.

Furthermore, the data before conversion may be a plurality of packets generated by splitting the above-described bitstream or file. Data that is different from the bitstream may be read from memory 1114 and then converted into a bitstream. In this case, decoding device 1110 may include a converter, not illustrated, and the converter may perform conversion processing, or conversion processing may be performed by a CPU that is an example of a processor, described later.

Decoder 1112 decodes input data 1113 to generate audio signal 1111 that indicates audio to be presented to the listener.

### Other Example of Encoding Device

FIG. 3C is a block diagram for illustrating a configuration example of another encoding device. Specifically, FIG. 3C illustrates the configuration of encoding device 1120, which is another example of the encoding device of the present disclosure. In FIG. 3C, constituent elements that are the same as the constituent elements in FIG. 3A have been given the same reference signs as in FIG. 3A, and description of these constituent elements is omitted.

Encoding device 1100 stores encoded data 1103 in memory 1104. On the other hand, encoding device 1120 is different from encoding device 1100 in the respect that encoding device 1120 includes transmitter 1121 that transmits encoded data 1103 externally.

Transmitter 1121 transmits, to a different device or server, transmission signal 1122 that is generated based on data converted from encoded data 1103 or encoded data 1103 to a different file format. The data used in generating transmission signal 1122 is, for example, the bitstream, multiplexed data, file, or packet described in relation to encoding device 1100.

### Other Example of Decoding Device

FIG. 3D is a block diagram for illustrating another configuration example of a decoding device. Specifically, FIG. 3D illustrates the configuration of decoding device 1130, which is another example of the decoding device of the present disclosure. In FIG. 3D, constituent elements that are the same as the constituent elements in FIG. 3B have been given the same reference signs as in FIG. 3B, and description of these constituent elements is omitted.

Decoding device 1110 reads input data 1113 from memory 1114. On the other hand, decoding device 1130 is different from decoding device 1110 in the respect that decoding device 1130 includes receiver 1131, which receives input data 1113 from an external source.

Receiver 1131 receives reception signal 1132 to obtain reception data, and outputs input data 1113 to be inputted into decoder 1112. The reception data may be the same as input data 1113 inputted into decoder 1112, or may be data in a data format that is different from that of input data 1113.

When the data format of the reception data is different from the data format of input data 1113, receiver 1131 may convert the reception data into input data 1113. Alternatively, a converter or a CPU, each not illustrated, of decoding device 1130 may convert the reception data into input data 1113. The reception data is, for example, the bitstream, multiplexed data, file, or packet described in relation to encoding device 1120.

### Example of Decoder

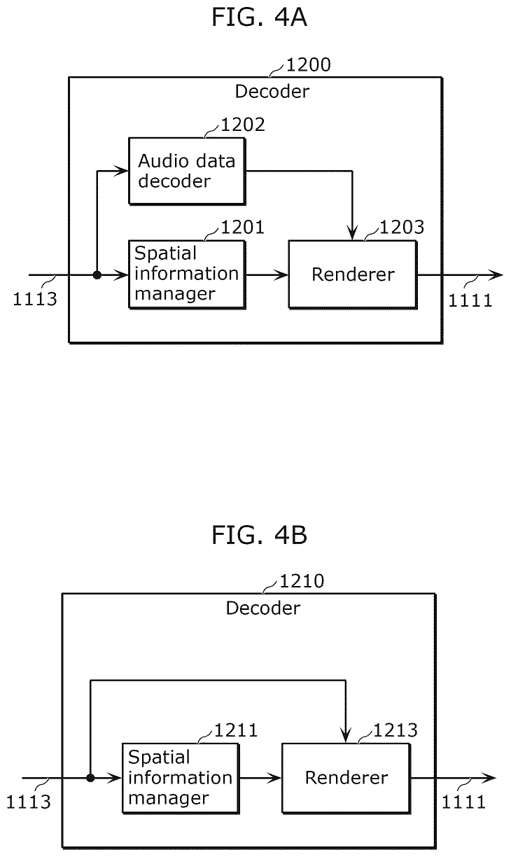

FIG. 4A is a block diagram for illustrating a configuration example of a decoder. Specifically, FIG. 4A illustrates the configuration of decoder 1200, which is an example of decoder 1112 in FIG. 3B and FIG. 3D.

Input data 1113 is an encoded bitstream, and includes encoded audio data that is an audio signal that has been encoded, and metadata used in acoustic processing.

Spatial information manager 1201 obtains the metadata included in input data 1113 and analyzes the metadata. The metadata includes information that describes the main factors that act on the sounds arranged in the sound space. Spatial information manager 1201 manages the spatial information that is obtained by analyzing the metadata and is used in the acoustic processing, and provides the spatial information to renderer 1203.

Note that in the present disclosure, the information used in the acoustic processing is expressed as spatial information, but another expression may be used. For example, the information used in the acoustic processing may be expressed as sound space information, or may be expressed as scene information. Furthermore, when the information used in the acoustic processing changes over time, the spatial information inputted into renderer 1203 may be information expressed as a spatial state, a sound space state, a scene state, or the like.

Moreover, the spatial information may be managed for each sound space or for each scene. For example, when each of a plurality of mutually differing rooms is expressed as a virtual space, the plurality of rooms may be managed as a plurality of scenes that mutually differ. Furthermore, spatial information may be managed such that even the same room is managed as a different scene in accordance with the expressed state.

Thus, a plurality of items of spatial information may be managed with respect to a plurality of sound spaces or a plurality of scenes. In management of a plurality of items of spatial information, an identifier that identifies each item of the plurality of items of spatial information may be assigned to the spatial information.

The spatial information data may be included in a bitstream that is an example of input data 1113. Alternatively, the bitstream may include an identifier of the spatial information, and the spatial information data may be obtained from an information source other than the bitstream. Specifically, when the bitstream includes only the identifier of the spatial information, in the rendering, the spatial information data stored in the memory inside the device or in an external server may be obtained as input data 1113, using the identifier of the spatial information.

Note that the information managed by spatial information manager 1201 is not limited to information included in the bitstream. For example, input data 1113 may include, as data not included in the bitstream, data that indicates the characteristics and structure of a space obtained from a VR or AR software application or server.

Furthermore, input data 1113 may include data that indicates the characteristics, position, and/or the like of the listener or an object. Moreover, input data 1113 may include information on the position of the listener, obtained using a sensor included in a terminal including a decoding device (1110, 1130), or may include information that indicates the position of the terminal, estimated based on information obtained using the sensor.

In other words, spatial information manager 1201 may communicate with an external system or server to obtain spatial information and the position of the listener. Furthermore, spatial information manager 1201 may obtain clock synchronization information from an external system and perform processing to perform synchronization with a clock in renderer 1203.

Note that the space in the above description may be a virtually formed space, i.e., a VR space, or may be a real-world space or a virtual space that corresponds to a real-world space, i.e., an AR space or an MR space. Furthermore, the virtual space may be expressed as a sound field or a sound space. Moreover, the information indicating position in the above description may be information on coordinates or the like that indicate a position in a space, may be information that indicates a relative position with respect to a predetermined reference position, or may be information that indicates movement or acceleration of a position in a space.

Audio data decoder 1202 decodes encoded audio data included in input data 1113 to obtain an audio signal.

The encoded audio data obtained by three-dimensional sound reproduction system 1000 is, for example, a bitstream encoded in a predetermined format such as MPEG-H 3D Audio (ISO/IEC 23008-3). Note that MPEG-H 3D Audio is merely an example of an encoding method that can be used when generating the encoded audio data included in the bitstream. The encoded audio data may be a bitstream encoded by another encoding method.

For example, the encoding method may be a lossy codec such as MPEG-1 Audio Layer III (MP3), Advanced Audio Coding (AAC), Windows Media Audio (WMA), Audio Codec 3 (AC3), Vorbis, or the like. Alternatively, the encoding method may be a lossless codec such as Apple Lossless Audio Codec (ALAC), Free Lossless Audio Codec (FLAC), or the like.

Alternatively, any encoding method other than the above-described may be used. For example, PCM data may be a type of the encoded audio data. In this case, when, for example, the quantization bit rate of the PCM data is N, the decoding processing may be processing in which the N-bit binary number is converted into a numerical format (for example, floating-point format) that can be processed by renderer 1203.

Renderer 1203 obtains the audio signal and the spatial information, applies acoustic processing to the audio signal using the spatial information, and outputs an acoustic-processed audio signal (audio signal 1111).

Before starting the rendering, spatial information manager 1201 reads the metadata of the input signal, detects rendering items such as objects and sounds specified by the spatial information, and transmits the rendering items to renderer 1203. After the start of rendering, spatial information manager 1201 grasps the change over time of the spatial information and the position of the listener, and updates and manages the spatial information. Then, the updated spatial information is transmitted to renderer 1203.

Renderer 1203 generates and outputs an acoustic processing-added audio signal based on the audio signal included in input data 1113 and the spatial information received from spatial information manager 1201.

Update processing of the spatial information and output processing of the acoustic processing-added audio signal may be performed in the same thread. Furthermore, processing may be allocated to spatial information manager 1201 and renderer 1203 in mutually independent threads. When spatial information manager 1201 and renderer 1203 perform the update processing of the spatial information and the output processing of the acoustic processing-added audio signal in different threads, the thread activation frequency may be set separately, or processing may be performed in parallel.

When spatial information manager 1201 and renderer 1203 perform processing in independent threads that are different, renderer 1203 can be preferentially allotted computation resources. This makes it possible to safely execute sound output processing for which even a slight delay is unallowable, i.e., for which a popping noise would be generated with a delay of even one sample (0.02 msec).

At this time, allotment of computation resources to spatial information manager 1201 is limited. However, since compared to the output processing of the audio signal, updating of the spatial information is processing that is infrequent (for example, processing such as updating the orientation of a listener's face), it is not necessary for the output processing of the audio signal to be performed instantaneously. Thus, even when the allotment of computation resources is limited, the acoustic quality is not greatly impacted.

The updating of the spatial information may be periodically performed with each elapse of a preset time period or term, or may be performed when a preset condition is satisfied. Furthermore, the updating of the spatial information may be performed manually by the listener or a sound space manager, or may be performed by being triggered by a change to an external system.

For example, the spatial information may be updated when a controller is being operated by the listener and the position of the listener's avatar is instantaneously warped or time is instantaneously progressed or reversed. Alternatively, the spatial information may be updated when an operation to suddenly change the field environment is performed by the manager of the virtual space. In these cases, the thread for updating the spatial information managed by spatial information manager 1201 may be activated as one-time interrupt processing in addition to the periodic activation.

For example, the update processing of the spatial information managed by spatial information manager 1201 is performed by an information updating thread.

The role of the information update thread includes, for example, processing to update the position and orientation of the listener's avatar in the virtual space based on the position and orientation of the VR goggles worn by the listener, and updating the position of objects moving within the virtual space. Such processing is handled within a processing thread that activates at a relatively low frequency of approximately several tens of Hz.

Processing that updates the information indicating the nature of direct sound may be performed in processing threads with low occurrence frequency. This is because the frequency at which the nature of direct sound changes is lower than the frequency of occurrence of audio processing frames for audio output. This makes it possible to relatively reduce the computational load of the processing. Furthermore, there is a risk of pulsive noise occurring due to unduly frequent information updates. Updating the information with low frequency makes it possible to avoid such a risk.

FIG. 4B is a block diagram for illustrating another configuration example of a decoder. Specifically, FIG. 4B illustrates the configuration of decoder 1210, which is another example of decoder 1112 in FIG. 3B and FIG. 3D.

FIG. 4B is different from FIG. 4A in the respect that input data 1113 includes not encoded audio data, but an unencoded audio signal. Input data 1113 includes an audio signal and a bitstream including metadata.

Spatial information manager 1211 is the same as spatial information manager 1201 in FIG. 4A; therefore, description thereof has been omitted.

Renderer 1213 is the same as renderer 1203 in FIG. 4A; therefore, description thereof has been omitted.

Note that decoders 1112, 1200, and 1210 may be expressed as the acoustic processor that performs the acoustic processing. Furthermore, decoding devices 1110 and 1130 may be audio signal processing device 1001, or may be expressed as the acoustic processing device.

### Physical Configuration of Audio Signal Processing Device

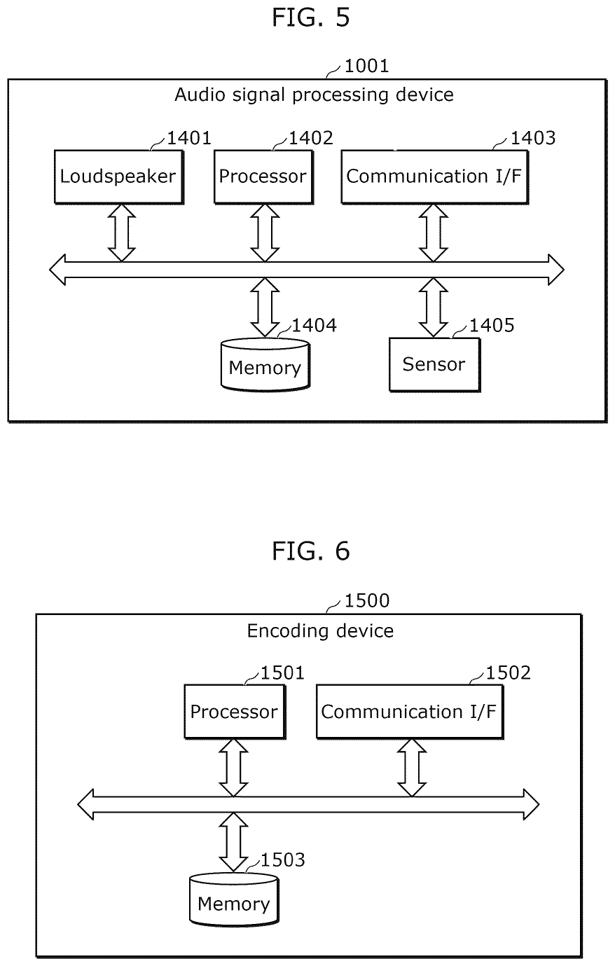

FIG. 5 is a diagram for illustrating an example of a physical configuration of audio signal processing device 1001. Note that audio signal processing device 1001 in FIG. 5 may be decoding device 1110 in FIG. 3B or decoding device 1130 in FIG. 3D. A plurality of the constituent elements illustrated in FIG. 3B or FIG. 3D may be implemented by a plurality of the constituent elements illustrated in FIG. 5. Furthermore, a part of the configuration described here may be included in audio presentation device 1002.

Audio signal processing device 1001 in FIG. 5 includes processor 1402, memory 1404, communication interface (I/F) 1403, sensor 1405, and loudspeaker 1401.

Processor 1402 is, for example, a CPU, a digital signal processor (DSP), or a graphics processing unit (GPU). The acoustic processing or decoding processing of the present disclosure may be performed by the CPU, DSP, or GPU executing a program stored in memory 1404. Moreover, processor 1402 is, for example, a circuit that performs information processing. Processor 1402 may be a dedicated circuit that performs signal processing on audio signals, including the acoustic processing of the present disclosure.

Memory 1404 includes, for example, random access memory (RAM) or read-only memory (ROM). Memory 1404 may include, for example, magnetic storage media, exemplified by a hard disk, or semiconductor memory, exemplified by an SSD. Furthermore, memory 1404 may be internal memory incorporated into the CPU or GPU. Moreover, spatial information managed by the spatial information manager (1201, 1211), and/or the like may be stored in memory 1404. Furthermore, threshold value data, described later, may be stored.

Communication I/F 1403 is, for example, a communication module that supports a communication method such as Bluetooth (registered trademark) or WiGig (registered trademark). Audio signal processing device 1001 communicates with other communication devices via communication I/F 1403, and obtains a bitstream to be decoded. The obtained bitstream is, for example, stored in memory 1404.

Communication I/F 1403 includes, for example, a signal processing circuit that supports the communication method, and an antenna. The communication method is not limited to Bluetooth (registered trademark) or WiGig (registered trademark), and may be Long Term Evolution (LTE), New Radio (NR), Wi-Fi (registered trademark), or the like.

The communication method is not limited to the wireless communication methods described above, and may be a wired communication method such as Ethernet (registered trademark), Universal Serial Bus (USB), High-Definition Multimedia Interface (HDMI) (registered trademark), or the like.

Sensor 1405 performs sensing to estimate the position or orientation of the listener. Specifically, sensor 1405 estimates the position and/or orientation of the listener based on one or more detection results of one or more of the position, orientation, movement, velocity, angular velocity, acceleration, or the like of a part or all of the listener's body, and generates position/orientation information indicating the position and/or orientation of the listener.

Note that a device outside of audio signal processing device 1001 may include sensor 1405. The part of the body may be the listener's head or the like. The position/orientation information may be information indicating the position and/or orientation of the listener in real-world space, or may be information indicating the displacement of the position and/or orientation of the listener with respect to the position and/or orientation of the listener at a predetermined time point. Furthermore, the position/orientation information may be information indicating a position and/or orientation relative to three-dimensional sound reproduction system 1000 or an external device including sensor 1405.

Sensor 1405 may be, for example, an imaging device such as a camera or a distance measuring device such as a laser imaging detection and ranging (LiDAR) distance measuring device. Sensor 1405 may capture an image of the movement of the listener's head and detect the movement of the listener's head by processing the captured image. Furthermore, a device that performs position estimation using radio waves in any given frequency band such as millimeter waves may be used as sensor 1405.

Furthermore, audio signal processing device 1001 may obtain position information via communication I/F 1403 from an external device including sensor 1405. In this case, audio signal processing device 1001 need not include sensor 1405. Here, the external device refers to, for example, audio presentation device 1002 described in FIG. 2, or a stereoscopic image reproduction device worn on the listener's head. In this case, sensor 1405 is configured as a combination of various sensors, such as a gyro sensor and an acceleration sensor, for example.

As the speed of the movement of the listener's head, sensor 1405 may detect, for example, the angular speed of rotation about at least one of three mutually orthogonal axes in the sound space as the axis of rotation or the acceleration of displacement in at least one of the three axes as the direction of displacement.

As the amount of the movement of the listener's head, sensor 1405 may detect, for example, the amount of rotation about at least one of three mutually orthogonal axes in the sound space as the axis of rotation or the amount of displacement in at least one of the three axes as the direction of displacement. Specifically, sensor 1405 detects 6DoF positions (x, y, z) and angles (yaw, pitch, roll) as the position of the listener. Sensor 1405 is configured as a combination of various sensors used for detecting movement, such as a gyro sensor and an acceleration sensor.

Note that sensor 1405 may implemented by, e.g., a camera or a Global Positioning System (GPS) receiver for detecting the position of the listener. Position information obtained by performing self-position estimation, by using LiDAR or the like as sensor 1405, may be used. For example, when three-dimensional sound reproduction system 1000 is implemented by a smartphone, sensor 1405 is included in the smartphone.

Furthermore, sensor 1405 may include a temperature sensor such as a thermocouple that detects the temperature of audio signal processing device 1001. Moreover, sensor 1405 may include, for example, a sensor that detects the remaining level of a battery included in audio signal processing device 1001 or a battery connected to audio signal processing device 1001.

Loudspeaker 1401 includes, for example, a diaphragm, a driving mechanism such as a magnet or a voice coil, and an amplifier, and presents the acoustic-processed audio signal as sound to the listener. Loudspeaker 1401 operates the driving mechanism according to the audio signal (more specifically, a waveform signal indicating the waveform of the sound) amplified via the amplifier, and vibrates the diaphragm by means of the driving mechanism. In this way, the diaphragm vibrating according to the audio signal generates sound waves, which propagate through the air and are transmitted to the listener's ears, allowing the listener to perceive the sound.

Note that although here, an example in which audio signal processing device 1001 includes loudspeaker 1401 and presents the acoustic-processed audio signal via loudspeaker 1401 was given, the means for providing the audio signal is not limited to this configuration.

For example, the acoustic-processed audio signal may be outputted to external audio presentation device 1002 connected via a communication module. The communication performed by the communication module may be wired or wireless. As another example, audio signal processing device 1001 may include a terminal that outputs an analog audio signal, and may present the audio signal from earphones or the like by connecting the earphone cable to the terminal.

In this case, audio presentation device 1002 may be headphones, earphones, a head-mounted display, neck speakers, wearable speakers, or the like, each worn on the listener's head or a part of the listener's body. Alternatively, audio presentation device 1002 may be surround speakers configured with a plurality of fixed speakers, or the like. Audio presentation device 1002 may reproduce the audio signal.

### Physical Configuration of Encoding Device

FIG. 6 is a diagram for illustrating an example of a physical configuration of an encoding device. Encoding device 1500 in FIG. 6 may be encoding device 1100 in FIG. 3A or encoding device 1120 in FIG. 3C, or a plurality of the constituent elements illustrated in FIG. 3A or FIG. 3C may be implemented by a plurality of the constituent elements illustrated in FIG. 6.

Encoding device 1500 in FIG. 6 includes processor 1501, memory 1503, and communication I/F 1502.

Processor 1501 is, for example, a CPU, a DSP, or a GPU. The encoding processing of the present disclosure may be performed by the CPU, the DSP, or the GPU executing a program stored in memory 1503. Furthermore, processor 1501 is, for example, a circuit that performs information processing. Processor 1501 may be a dedicated circuit that performs signal processing on audio signals, including the encoding processing of the present disclosure.

Memory 1503 includes, for example, RAM or ROM. Memory 1503 may include, for example, magnetic storage media, exemplified by a hard disk, or semiconductor memory, exemplified by an SSD. Furthermore, memory 1503 may be an internal memory incorporated into the CPU or GPU.

Communication I/F 1502 is, for example, a communication module that supports a communication method such as Bluetooth (registered trademark) or WiGig (registered trademark). For example, encoding device 1500 communicates with other communication devices via communication I/F 1502, and transmits an encoded bitstream.

Communication I/F 1502 includes, for example, a signal processing circuit that supports the communication method, and an antenna. The communication method is not limited to Bluetooth (registered trademark) or WiGig (registered trademark), and may be LTE, NR, Wi-Fi (registered trademark), or the like. The communication method is not limited to wireless communication methods. The communication method may be a wired communication method such as Ethernet (registered trademark), USB, HDMI (registered trademark), or the like.

### Configuration of Renderer

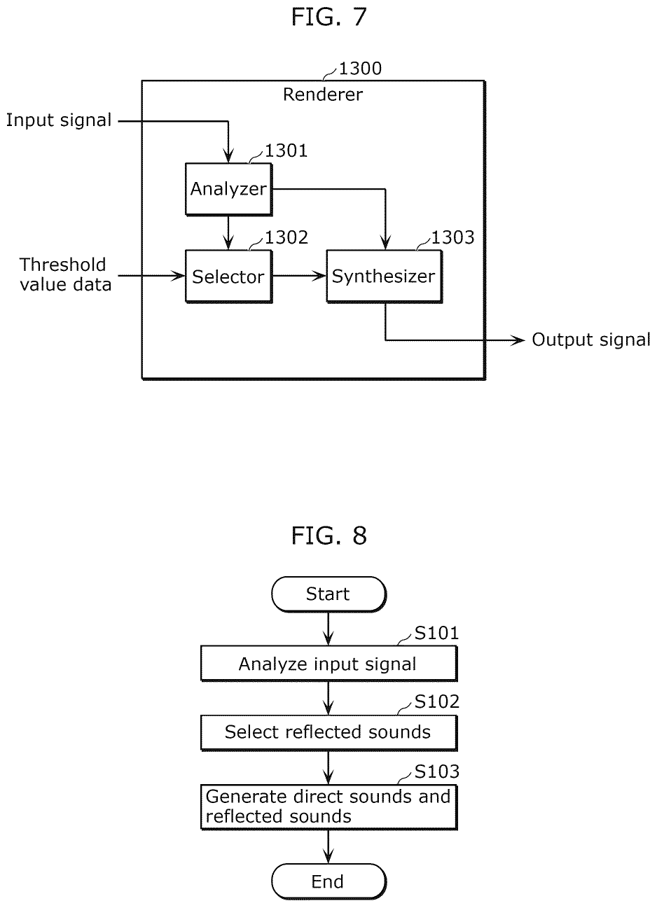

FIG. 7 is a block diagram for illustrating a configuration example of a renderer. Specifically, FIG. 7 illustrates an example of the detailed configuration of renderer 1300, which corresponds to renderers 1203 and 1213 in FIG. 4A and FIG. 4B.

Renderer 1300 includes analyzer 1301, selector 1302, and synthesizer 1303, and adds acoustic processing to sound data included in the input signal and outputs the sound data.

The input signal includes, for example, spatial information, sensor information, and sound data. The input signal may include a bitstream that includes sound data and metadata (control information), and in this case, the spatial information may be included in the metadata.

The spatial information is information related to the sound space (three-dimensional sound field) created by three-dimensional sound reproduction system 1000, and includes information about objects included in the sound space and information about the listener. The objects include sound source objects that emit sound and serve as sound sources, and non-sound-emitting objects that do not emit sound. The sound source objects may be expressed as simply sound sources.

The non-sound-emitting object serves as an obstacle object that reflects sound emitted by the sound source object, but a sound source object may also serve as an obstacle object that reflects sound emitted by another sound source object. The obstacle object may also be expressed as a reflection object.

Information assigned in common to both sound source objects and non-sound-emitting objects includes position information, geometry information, and the attenuation rate of sound volume when the object reflects sound.

The position information is represented by coordinate values of three axes, for example, the X-axis, the Y-axis, and the Z-axis of Euclidean space, but it does not necessarily have to be three-dimensional information. For example, the position information may be two-dimensional information represented by coordinate values of the two axes of the X-axis and the Y-axis. The position information of the object is defined by a representative position of the shape expressed by a mesh or voxel.

The geometry information may include information about the material of the surface.

The attenuation rate may be expressed as a real number greater than or equal to 0 and less than or equal to 1, or may be expressed as a negative decibel value. Since sound volume does not increase from reflection in real-world space, the attenuation rate is set to a negative decibel value. However, for example, to create an eerie atmosphere in a non-realistic space, an attenuation rate greater than or equal to 1, that is, a positive decibel value, may be intentionally set.

Furthermore, the attenuation rate may be set such that each frequency band included in a plurality of frequency bands has a different value, or values may be independently set for each frequency band. Furthermore, when the attenuation rate is set for each type of material of an object surface, the value of the corresponding attenuation rate may be used based on information about the surface material.

Furthermore, the spatial information may include, for example, information indicating whether the object belongs to an animate thing or information indicating whether the object is a mobile body. When the object is a mobile body, the position indicated by the position information may move over time. In this case, information on the changed position or the amount of change is transmitted to renderer 1300.

Information related to the sound source object includes, in addition to information assigned in common to both sound source objects and non-sound-emitting objects, sound data and information necessary for radiating the sound data into the sound space. The sound data is data representing sound perceived by the listener, and indicates information such as the frequency and intensity of the sound.

The sound data is typically a PCM signal, but may also be data compressed using an encoding method such as MP3. In this case, since the signal needs to be decoded at least before arriving at generator 1303, renderer 1300 may include a decoder (not illustrated). Alternatively, the signal may be decoded by audio data decoder 1202.

One item of sound data may be set for one sound source object, or a plurality of items of sound data may be set. Furthermore, identification information for identifying each item of sound data may be assigned to the sound data, or information related to the sound source object may include identification information for the sound data.

As information necessary for radiating sound data into the sound space, for example, information on a reference sound volume that is used as a standard in reproducing the sound data, information related to the position of the sound source object, information related to the orientation of the sound source object (in other words, information related to the directivity of the sound emitted by the sound source object), and the like may be included.

The information on the reference sound volume may be, for example, the root mean square value of the amplitude value of the sound data at the sound source position at the time of radiating the sound data into the sound space, and may be expressed as a floating-point decibel (dB) value.

For example, when the reference sound volume is 0 dB, the information on the reference sound volume may indicate that the sound is to be radiated into the sound space from the position indicated by the information related to the position of the sound source object, at the same sound volume as the signal level indicated by the sound data, without increase or decrease. Furthermore, when the reference sound volume is −6 dB, this may indicate that the sound is to be radiated into the sound space from the position indicated by the information related to the position of the sound source object at approximately half the sound volume of the signal level indicated by the sound data.

The information on the reference sound volume may be assigned to each item of sound data, or may be assigned collectively to a plurality of items of sound data.

The information necessary for radiating sound data into the sound space may include as information on sound volume, for example, information indicating the chronological variation in the sound volume of a sound source.

For example, when the sound space is a virtual conference room and the sound source is a speaker, the sound volume transitions intermittently over short periods of time. In other words, sound portions and silent portions occur alternately. Furthermore, when the sound space is a concert hall and the sound source is a performer, the sound volume is maintained over a certain duration of time. Moreover, when the sound space is a battlefield and the sound source is an explosive, the sound volume of the explosion sound becomes large for only an instant and then continues to be silent or in a quiet state thereafter.

In this way, the sound volume information on the sound source may include not only information on the magnitude of sound but also information on the transition of the sound magnitude. Such information may be used as information indicating the nature of the sound data.

The information on the transition may be expressed by data indicating frequency characteristics in chronological order. The information on the transition may be expressed by data indicating the duration of a sound interval. The information on the transition may be expressed by data indicating the chronological order of durations of sound intervals and durations of silent intervals. The information on the transition may be expressed by, for example, data that enumerates, in chronological order, a plurality of sets of a duration for which the amplitude of the sound signal can be considered stationary (can be considered approximately constant) and the amplitude value of said signal during that duration.

The information on the transition may be expressed by data of a duration for which the frequency characteristics of the sound signal can be considered stationary. The information on the transition may be expressed by, for example, data that enumerates, in chronological order, a plurality of sets of a duration for which the frequency characteristics of the sound signal can be considered stationary and the frequency characteristics during that duration. The information on the transition may be expressed in the format of, for example, data indicating the general shape of a spectrogram.

Furthermore, the sound volume that is used as the standard for the above-mentioned frequency characteristics may be used as the reference sound volume. The information on the reference sound volume and the information indicating the nature of the sound data may be used for calculation processing of the sound volume of direct sound or reflected sound to be perceived by the listener, and/or may be used for selection processing for selecting whether to make the listener perceive the sound. Other examples of and usage methods for the sound volume information will be described later.

Information regarding the orientation of a sound source object (orientation information) is typically expressed in terms of yaw, pitch, and roll. Alternatively, the rotation of roll may be omitted, and the orientation information of a sound source object may be expressed in terms of azimuth (yaw) and elevation (pitch). The orientation information of a sound source object may change over time, and when changed, the orientation information is transmitted to renderer 1300.

Information related to the listener is information regarding the position and orientation of the listener in the sound space. The information regarding the position (position information) is represented by the position on the X-, Y-, and Z-axes of Euclidean space, but need not necessarily be three-dimensional information and may be two-dimensional information. Information regarding the orientation of the listener (orientation information) is typically expressed in terms of yaw, pitch, and roll. Alternatively, the rotation of roll may be omitted, and the listener orientation information may be expressed in terms of azimuth (yaw) and elevation (pitch).

The position information and orientation information regarding a listener may change over time, and when changed, the position information and orientation information are transmitted to renderer 1300.

The sensor information is information that includes, e.g., the rotation amount or displacement amount detected by sensor 1405 worn by the listener, and the position and orientation of the listener. The sensor information is transmitted to renderer 1300, and renderer 1300 updates the information on the position and orientation of the listener based on the sensor information. The sensor information may include position information obtained by performing self-localization estimation by a mobile terminal using GPS, a camera, or LiDAR, for example.

Furthermore, information obtained not from sensor 1405, but from an external source through a communication module, may also be detected as sensor information. Information indicating the temperature of audio signal processing device 1001, and information indicating the remaining level of the battery may be obtained from sensor 1405. Moreover, computational resources (CPU capability, memory resources, PC performance, and the like) of audio signal processing device 1001 or audio presentation device 1002 may be obtained in real time.

Analyzer 1301 analyzes an audio signal included in the input signal and spatial information received from the spatial information managers (1201, 1211) to detect the information required for generating direct sounds and reflected sounds, and the information required for selecting whether to generate reflected sounds.

The information necessary for generating direct sounds and reflected sounds is, for example, information on the characteristics of the direct sounds and reflected sounds that can be generated in a sound space. The reflected sounds detected here are candidates for the reflected sounds to be selected by selector 1302 as the reflected sounds to be ultimately generated by synthesizer 1303. The characteristics of the direct sounds and the reflected sounds are, for example, the arrival time period (arrival time) and arrival time sound volume when each of the direct sounds and the reflected sounds arrive at the listener. When a plurality of objects are present in the sound space as reflection objects, reflected sound characteristics with respect to each of the plurality of objects are calculated.

The information required for selecting a reflected sound to be output may be, for example, information that indicates the upper limit of an evaluation value and computation resources of the reflected sound, or may be information for calculating information that indicates the evaluation value and the upper limit of the computation resources of the reflected sound. In other words, analyzer 1301 may obtain the evaluation value of the reflected sound from an external device, a storage, or an input signal. Alternatively, analyzer 1301 or selector 1302 may, using the information obtained by analyzer 1301 from the external device, the memory, or the input signal, calculate information that indicates the evaluation value and the upper limit of the computation resources of the reflected sound.

Selector 1302 determines whether to select a reflected sound based on the evaluation value of the reflected sound. In other words, selector 1302 preferentially selects a reflected sound having a high evaluation value over a reflected sound having a low evaluation value. The evaluation value of a reflected sound is a value of the reflected sound that, for example, corresponds to the sensory level of importance of the reflected sound. The evaluation value is higher as the sensory level of importance of the reflected sound is greater. The sensory level of importance of a reflected sound refers to the degree of necessity of a reflected sound that is used for allowing the listener to correctly grasp the positioning of sound source objects in a sound space and the size of the space.

Due to reflected sounds having a high evaluation value, i.e., reflected sounds having a high sensory level of importance, being preferentially selected and processed, the listener is able to grasp the positioning of sound images such as the direction of arrival of sounds and the sense of distance of sound source objects, and the size and material properties of the space.

Furthermore, by determining the reflected sounds that are not to be selected before starting the reflected sound generation processing, it is possible to decide to skip processing starting with the processing to assign acoustic effects to reflected sounds. Therefore, it is possible to reduce the computational load compared to a case of deciding whether to perform binaural processing after assigning acoustic effects to all reflected sounds detected, or a case of performing binaural processing on all reflected sounds detected.

In other words, by determining the reflected sounds that are not to be selected based on the levels of importance of reflected sounds, it is possible to reduce the computation load used for generation of the reflected sounds while preventing the impairment of the listener being able to grasp the positioning of sounds and the space.

Selector 1302 calculates the evaluation values by evaluating the sensory levels of importance of reflected sounds in accordance with, for example, information on the sound volume of sound sources, the visual properties of sound sources, the positionality of sound sources, the visual properties of reflection objects (obstacle objects), and the material of reflection objects, and geometrical relationships between direct sounds and reflected sounds. Other indicators may also be used in the evaluation of the sensory levels of importance of the reflected sounds. The evaluation values of reflected sounds may be calculated based on any one indicator among a plurality of indicators relating to the sensory levels of importance of reflected sounds, or the evaluation levels of reflected sounds may be comprehensively calculated using a plurality of indicators.

Furthermore, selector 1302 may obtain the evaluation values of reflected sounds from an external device or storage, or may obtain the evaluation values from the input signal.

Specifically, the evaluation value may become higher as the sound volume of the sound source is greater. Furthermore, in order to cause visual positioning and acoustic positioning to match each other, the evaluation value may be high when a sound source object or a reflection object (obstacle object) is visible from the listener, or when the positionality of a sound source object is high.

Moreover, the size of the arrival angle formed by a direct sound and a reflected sound and the difference between the arrival time periods of a direct sound and a reflected sound greatly affect the grasping of the space. Thus, the evaluation value may be high when the size of the angle formed by the arrival of a direct sound and the arrival of a reflected sound is large, or when the difference between the arrival time periods of a direct sound and a reflected sound is large.

Furthermore, the evaluation value of a reflected sound may be calculated using information on the difference between the arrival time periods of the direct sound and the reflected sound. In this case, for example, a masking threshold value relating to a temporal masking phenomenon (post-masking phenomenon), a known phenomenon, may be used.

The specific methods for using selector 1302 to evaluate and select reflected sounds will be described later.

Synthesizer 1303 synthesizes audio signals for direct sounds with audio signals for the reflected sounds selected for generation by selector 1302.

Specifically, synthesizer 1303 processes the audio signal inputted to generate direct sound, based on information on the direct sound arrival time and the direct sound arrival time sound volume calculated by analyzer 1301. Furthermore, synthesizer 1303 processes the audio signal inputted to generate reflected sound, based on information on the reflected sound arrival time and the reflected sound arrival time sound volume pertaining to the reflected sounds selected by selector 1302. Then, synthesizer 1303 synthesizes and outputs the direct sound and reflected sound that were generated.

### Operation of Renderer

FIG. 8 is a flowchart for illustrating an operation example of audio signal processing device 1001. FIG. 8 illustrates the processing performed mainly by renderer 1300 of audio signal processing device 1001.

### Detection of Direct Sounds and Reflected Sounds

In the analysis processing of the input signal (S101 in FIG. 8), analyzer 1301 analyzes the input signal inputted into audio signal processing device 1001 to detect direct sounds and reflected sounds that may be generated in the sound space. The reflected sounds detected here are candidates for the reflected sounds to be selected by selector 1302 as the reflected sounds to be ultimately generated by synthesizer 1303. Furthermore, analyzer 1301 analyzes the input signal to calculate information necessary for generating direct sound and reflected sound, and information necessary for selecting the reflected sounds to be generated.

First, the characteristics of each of the direct sound and the reflected sound are calculated. Specifically, the arrival time period and the arrival time sound volume when each of the direct sound and the reflected sound arrive at the listener are calculated. When a plurality of objects are present in the sound space as reflection objects, reflected sound characteristics with respect to each of the plurality of objects are calculated.

The direct sound arrival time period (td) is calculated based on the direct sound arrival path (pd). The direct sound arrival path (pd) is a path that connects position information (S) (xs, ys, zs) of a sound source object with position information A (xa, ya, za) of the listener. The direct sound arrival time period (td) is a value obtained by dividing the length of the path that connects position information (S) (xs, ys, zs) with position information A (xa, ya, za), by the speed of sound (approximately 340 m/sec).

For example, the path length (X) is determined by the expression ((xs−xa)\hat{ }2+(ys−ya)\hat{ }2+(zs−za)\hat{ }2)\hat{ }0.5. The sound volume attenuates in inverse proportion to the distance. Thus, when the sound volume at position information S (xs, ys, zs) of a sound source object is denoted by N and the unit distance is denoted by U, the direct sound arrival time sound volume (ld) is determined by the expression ld=N*U/X.

Sound volume N at the sound source position may be the reference sound volume described above.

The reflected sound arrival time period (tr) is calculated based on the reflected sound arrival path (pr). The reflected sound arrival path (pr) is a path that connects the position of the sound image of a reflected sound with position information A (xa, ya, za).

Note that the position of the sound image of the reflected sound may be derived by using, for example, a “mirror image method” or a “ray tracing method”, or by using any other method for deriving sound image positions. The mirror image method is a method that simulates a sound image by assuming that a reflected wave on the wall in a room has a mirror image in a position symmetrical to the sound source with respect to the wall, and that sound waves are emitted from the position of that mirror image. The ray tracing method is a method that simulates, for example, an image (sound image) observed at a certain point by tracing waves that are transmitted in a linear manner, such as light rays or sound rays.

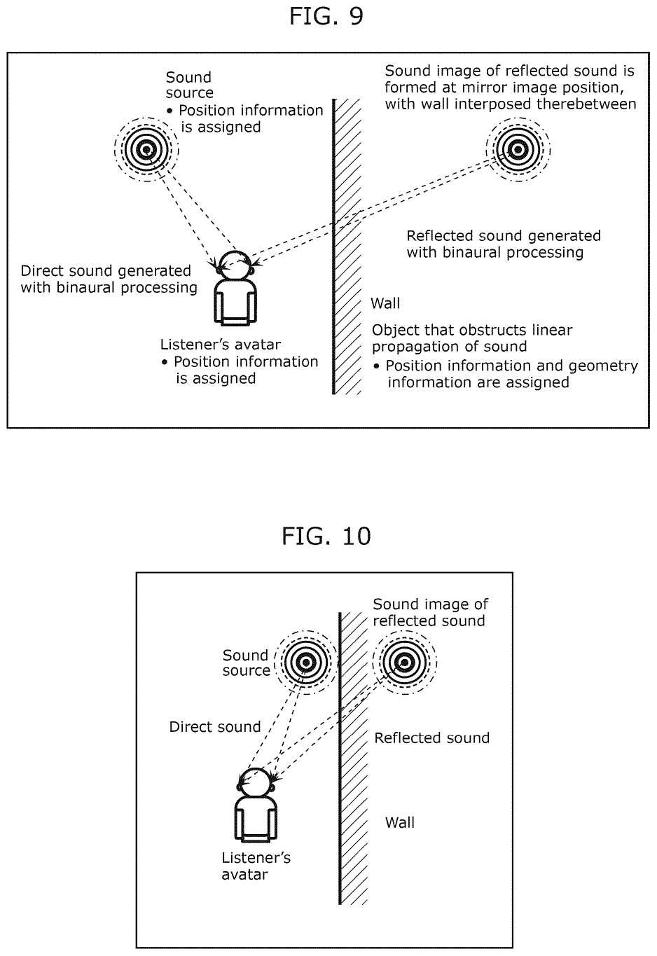

FIG. 9 is a diagram for illustrating a comparatively distant positional relationship between a listener and an obstacle object. FIG. 10 is a diagram for illustrating a comparatively close positional relationship between a listener and an obstacle object. In other words, each of FIG. 9 and FIG. 10 illustrate an example in which the sound image of a reflected sound is formed in a position symmetrical to the sound source position, with a wall interposed therebetween. Based on such a relationship, by determining the position of the sound image of the reflected sound on the x-, y-, and z-axes, the arrival time period of a reflected sound can be determined in the same manner as the method for calculating the arrival time period of a direct sound.

The reflected sound arrival time period (tr) is a value obtained by dividing the length of the path that connects the position of the sound image of a reflected sound with position information A (xa, ya, za), by the speed of sound (approximately 340 m/sec). The sound volume attenuates in inverse proportion to the distance. Thus, when the sound volume at the sound source position is denoted by N, the unit distance is denoted by U, and the attenuation rate of the sound volume at the reflection is denoted by G, the reflected sound arrival time sound volume (lr) is determined by the expression lr=N*G*U/Y.

As described above, attenuation rate G may be expressed as a real number greater than or equal to 0 and less than or equal to 1, or may be expressed as a negative decibel value. In this case, the sound volume of the signal as a whole attenuates by the amount of G. Furthermore, the attenuation rate may be set for each frequency band included in a plurality of frequency bands. In this case, analyzer 1301 multiplies each frequency component of the signal by the specified attenuation rate. Furthermore, in order to reduce the amount of computation, analyzer 1301 may, by using, as an overall attenuation rate, a representative value, an average value, or the like of a plurality of attenuation rates of a plurality of frequency bands, cause the sound volume of the signal as a whole to attenuate by that amount.

### Reflected Sound Selection Processing

Next, in reflected sound selection processing (S102 in FIG. 8), selector 1302 selects whether to generate a reflected sound calculated by analyzer 1301. To put it differently, selector 1302 assesses whether to select a reflected sound as a reflected sound to be generated. When there are a plurality of reflected sounds, selector 1302 selects whether to generate each reflected sound. As the result of selecting whether to generate each reflected sound, selector 1302 may select one or more reflected sounds to be generated from the plurality of reflected sounds, or may select one reflected sound to be generated.

Note that selector 1302 may select reflected sounds to which other processing is to be applied, not limited to generation processing. For example, selector 1302 may select reflected sounds to which binaural processing is to be applied. Furthermore, selector 1302 fundamentally selects only the one or more reflected sounds that are to be processed. However, selector 1302 may select only one or more reflected sounds that are not to be processed. Processing may then be applied to the one or more reflected sounds that were not selected.

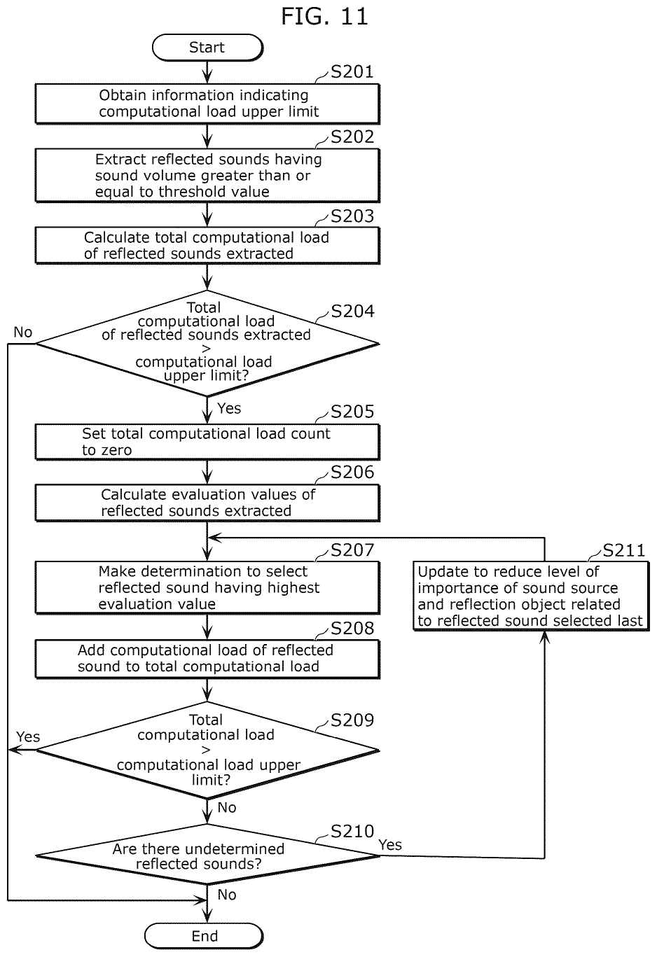

For example, the selection of the reflected sounds may be performed based on the allowable computation load and the sensory levels of importance of the reflected sounds. The flow of the reflected sound selection processing is described with reference to the flowchart in FIG. 11.

FIG. 11 is a flowchart for illustrating an example of reflected sound selection processing. Note that in this example, the selection processing is performed based on the computational load and the sensory levels of importance of the reflected sounds, but the selection processing may be performed based on only one of these.

### Obtaining of Information Indicating Upper Limit of Computational Load

First, selector 1302 obtains information indicating the computational load upper limit in audio signal processing device 1001 (S201). The information indicating the computational load upper limit may be predetermined by the listener, or may be obtained from the input signal.

Here, the information indicating the computational load upper limit may indicate, as the upper limit, the total number of the (one or more) reflected sounds, or may indicate the amount of processing required for the (one or more) reflected sounds. Since, when the information indicating the computational load upper limit indicates the total number of reflected sounds as the upper limit, the predicted value of the total number of reflected sounds is also used as the predicted value of the computational load of the reflected sound candidates, described later, the amount of processing by selector 1302 can be reduced compared to when calculating the predicted value of the amount of processing required for the reflected sounds.

Since, when the information indicating the computational load upper limit indicates the amount of processing required for the reflected sounds as the upper limit, the predicted value of the amount of processing required for the reflected sounds is also used as the predicted value of the computational load of the reflected sound candidates, described later, a more accurate computational load can be predicted. Note that the amount of processing required for the (one or more) reflected sounds is, for example, the amount of processing required for generating the (one or more) reflected sounds, and is the total amount of computation expended in processing to generate the (one or more) reflected sounds.

The reflected sound processing is, for example, processing to generate reflected sounds, and is processing that is included in pipeline processing. Pipeline processing includes, for example, reverberation processing, early reflection processing, distance attenuation processing, binaural processing, diffraction processing, and occlusion processing.

However, these processes are examples, and the pipeline processing may include processes other than these, and may not include a part of these processes. For example, renderer 1300 may perform diffraction processing and occlusion processing as the pipeline processing. Furthermore, for example, the reverberation processing may be omitted when unneeded.

The information indicating the computational load upper limit may be determined in accordance with the computation resources (CPU capability, memory resources, PC performance, remaining level of battery, etc.) of audio signal processing device 1001 or audio presentation device 1002. For example, CPU processing capabilities generally increase in the order of head-mounted display, VR/AR goggles, smartphones, laptop PCs, desktop PCs, and supercomputers; thus, the computational load upper limit may also be set to increase in the same order.

Furthermore, selector 1302 may obtain information indicating the device temperature or the information indicating the remaining level of the battery from sensor 1405 included in audio signal processing device 1001 or audio presentation device 1002. Moreover, selector 1302 may obtain computational resources (CPU capability, memory resources, PC performance, etc.) of audio signal processing device 1001 or audio presentation device 1002 in real time.

In the above-described case, selector 1302 may also obtain the information indicating the computational load upper limit in real time, or this information may be periodically performed when the spatial information is updated by the spatial information manager (1201, 1211).

Furthermore, the information indicating the computational load upper limit may be set in accordance with the battery life of audio signal processing device 1001 or audio presentation device 1002.

Alternatively, the computational load upper limit may be set for each of modes such as “energy-saving mode” in which the device can be used over a long period of time with a small amount of computation or “high-performance mode” in which the amount of computation is high, but many reflected sounds can be heard. In this case, the desired battery life or the desired mode may be set by the listener, the manager who manages three-dimensional sound reproduction system 1000, or the creator of the three-dimensional sound content. Moreover, the computational load upper limit can be directly inputted without selecting a mode.

Furthermore, information indicating the computational load upper limit may be set for each type of content to be reproduced by three-dimensional sound reproduction system 1000. For example, the computational load upper limit may be set higher for content for which a sense of immersion is more important, whereby a greater number of reflected sounds may be selected. The computational load upper limit may be set lower for content for which real-time characteristics are important, such that delays do not occur in conjunction with an increase in the amount of processing. In this way, the selection of many reflected sounds is inhibited.

Information indicating the computational load upper limit may be included in an input signal that includes content. Furthermore, selector 1302 may determine the computational load upper limit based on information that indicates classifications of the content or classifications of the modes included in the input signal. Alternatively, selector 1302 may determine the computational load upper limit based on other flags or parameters included in the input signal, not limited to information that indicates classifications of the content or classifications of the modes.

### Extraction of Reflected Sounds Having Sound Volume Greater Than or Equal to Threshold Value

Next, selector 1302 extracts, from the (one or more) reflected sounds detected by analyzer 1301, (one or more) reflected sounds having an arrival time sound volume greater than or equal to the threshold value, as selection candidate(s) (S202). In other words, selector 1302 makes a determination to skip subsequent processing for the (one or more) reflected sounds having arrival time sound volume that is lower than the threshold value.

Furthermore, when the arrival time sound volume of a direct sound is lower than the threshold value, selector 1302 may skip extracting the reflected sound originating from the direct sound. The arrival time sound volume of reflected sounds is lower than the arrival time sound volume of direct sounds. Therefore, when the arrival time sound volume of a direct sound is lower than the threshold limit, the arrival time sound volume of the reflected sounds originating from the direct sound is also lower than the threshold limit.

Thus, selector 1302 may extract, from reflected sounds originating from a direct sound having an arrival time sound volume greater than or equal to the threshold limit, reflected sounds having an arrival time sound volume greater than or equal to the threshold limit.

In other words, selector 1302 may compare the arrival time sound volume of the direct sound with the threshold value beforehand. This makes it possible, when the arrival time sound volume of a direct sound is lower than the threshold value, to decide to skip extracting a plurality of reflected sounds originating from the direct sound. Thus, it is possible to reduce the amount of computation compared to when, for each of a plurality of reflected sounds originating from the direct sound, calculating the arrival time sound volume of the reflected sound, and deciding whether to extract the reflected sound.

Here, the threshold value to be compared with the arrival time sound volume of a direct sound or a reflected sound may be a minimum sound volume to be reproduced in a sound space. In other words, the threshold value may be a minimum audible limit that indicates the boundary sound volume demarcating whether a sound can be perceived by the listener. Furthermore, for example, sound having a sound volume lower than this threshold limit may, as a sound that cannot be perceived by the listener, not be reproduced in the virtual space.

Furthermore, the threshold value may be decided in advance by the listener, or may be obtained from the input signal. The threshold value of the arrival time sound volume may be determined in accordance with the computation resources (CPU capability, memory resources, PC performance, remaining level of battery, etc.) of audio signal processing device 1001 or audio presentation device 1002. For example, CPU processing capabilities generally increase in the order of head-mounted displays, VR/AR goggles, smartphones, laptop PCs, desktop PCs, and supercomputers; thus, the threshold value of the arrival time sound volume may also be set to increase in the same order.

Furthermore, selector 1302 may obtain, from sensor 1405 included in audio signal processing device 1001 or audio presentation device 1002, information indicating the device temperature or information indicating the remaining level of the battery. Moreover, selector 1302 may obtain computational resources (CPU capability, memory resources, PC performance, etc.) of audio signal processing device 1001 or audio presentation device 1002 in real time.

In the above-described case, selector 1302 may also obtain the threshold value of the arrival time sound volume in real time, or the threshold value of the arrival time sound volume may be periodically obtained when the spatial information is updated by the spatial information manager (1201, 1211).

Furthermore, the threshold value of the arrival time sound volume may be set in accordance with the battery life of audio signal processing device 1001 or audio presentation device 1002.

Alternatively, the threshold value of the arrival time sound volume may be set for each of modes such as “energy-saving mode” in which the device can be used over a long period of time with a small amount of computation or “high-performance mode” in which the amount of computation is high, but many reflected sounds can be heard. In this case, the desired battery life or the desired mode may be set by the listener, the manager who manages three-dimensional sound reproduction system 1000, or the creator of the three-dimensional sound content. Moreover, the threshold value of the arrival time sound volume can be directly inputted without the mode being selected.

Furthermore, the threshold value of the arrival time sound volume may be set for each type of content to be reproduced by three-dimensional sound reproduction system 1000. For example, the threshold value of the arrival time sound volume may be set higher for content for which a sense of immersion is more important, whereby a greater number of reflected sounds may be selected. The threshold value of the arrival time sound volume may be set lower for content for which real-time characteristics are important, such that delays do not occur in conjunction with an increase in the amount of processing. In this way, the selection of many reflected sounds is inhibited.

The threshold value of the arrival time sound volume may be included in an input signal that includes content. Furthermore, selector 1302 may determine the threshold value of the arrival time sound volume based on information that indicates classifications of the content or classifications of the modes included in the input signal. Alternatively, selector 1302 may determine the threshold value of the arrival time sound volume based on other flags or parameters included in the input signal, not limited to information that indicates classifications of the content or classifications of the modes.

### Calculation of Predicted Value of Total Computational Load

Next, selector 1302 calculates the predicted value of the total computational load of all reflected sounds that were extracted as selection candidates and have an arrival time sound volume greater than or equal to the threshold value (S203). Here, the predicted value of the computational load may be the total number of the (one or more) reflected sounds, or may be the predicted value of the amount of processing required for the (one or more) predicted sounds.

Whether to use the total number of reflected sounds or the predicted value of the amount of processing required for the reflected sounds as the predicted value of the computational load may be decided based on whether the information indicating the computational load upper limit, described above, indicates the total number of reflected sounds or the amount of processing required for the reflected sounds as the upper limit.

When the predicted value of the computational load is the total number of reflected sounds, it is possible to reduce the amount of processing by selector 1302 further than when the predicted value of the computational load is the predicted value of the amount of processing required for the reflected sounds. When the predicted value of the computational load is the predicted value of the amount of processing required for the reflected sounds, the computational load can be more accurately predicted due to calculating the total computational load required for generating the (one or more) reflected sounds.

As described above, the reflected sound processing is, for example, processing to generate reflected sounds, and is processing that is included in pipeline processing.

Whether, for each type of processing included in the pipeline processing, the processing is required differs based on the nature of the reflected sound. Thus, the predicted value of the amount of computation in the pipeline processing (in other words, the amount of processing required for the one or more reflected sounds) may be different for each reflected sound.

Furthermore, in order to reduce the processing load for predicting the amount of computation in the pipeline processing, it may be assumed that the same processing will be performed on each reflected sound, and the predicted value of the amount of processing required for all the reflected sounds may be calculated. In other words, the same predicted value may be applied as the predicted value of the amount of processing required for each reflected sound, and the predicted value of the amount of processing required for all the reflected sounds may be calculated.

Note that in the calculation of the predicted value of the total computational load, the predicted value of the total computational load of a plurality of reflected sounds may be calculated, or the predicted value of the total computational load of one reflected sound may be calculated.

Furthermore, the reflected sounds to be used in calculation of the predicted value of the total computational load may be all the reflected sounds extracted as selection candidates, or may be only a part of the reflected sounds extracted as the selection candidates. When only a part of the reflected sounds extracted as the selection candidates are used in calculation of the predicted value of the total computational load, the predicted value of the total number or the amount of processing required for the part of the reflected sounds may be used as the predicted value of the total computational load.

### Comparison of Predicted Value of Total Computational Load With Upper limit of Computational Load

Next, selector 1302 compares the predicted value of the total computational load calculated with the computational load upper limit, and assesses whether the predicted value of the total computational load exceeds the computational load upper limit (S204). When the predicted value of the total computational load exceeds the computational load upper limit (“Yes” in S204), selector 1302 performs the selection processing (S205 to S211) based on the evaluation values. When the predicted value of the total computational load does not exceed the computational load upper limit (“No” in S204), selector 1302 selects all the reflected sounds extracted as the selection candidates and ends the processing.

### Selection of Reflected Sounds Based on Evaluation Values

In the selection processing based on the evaluation values, selector 1302 calculates, for each reflected sound that is a selection candidate, an evaluation value of the reflected sound based on the sensory level of importance, and controls whether to select the reflected sound based on the evaluation value. For example, selector 1302 selects the reflected sounds in descending order, starting with the reflected sound having the highest evaluation value. The specific method of calculating the evaluation value of each reflected sound will be described later. Here, an example of selection processing in which reflected sounds are selected based on evaluation values will be described.

For example, selector 1302 performs loop processing in which the computational loads of the reflected sounds selected are added, in order, and when the total exceeds the computational load upper limit, selector 1302 stops the selection processing (S205 to S211). In other words, when the total value of the computational loads of the one or more reflected sounds selected exceeds the computational load upper limit (“Yes” in S209), selector 1302 determines that the remaining unassessed reflected sounds are reflected sounds that are not to be selected, and ends the selection processing.

Specifically, selector 1302 first sets the total computational load count to zero (S205). Furthermore, selector 1302 calculates the evaluation value of each reflected sound extracted (S206). Then, selector 1302 makes a determination to select the reflected sound having the highest evaluation value (S207). Furthermore, selector 1302 adds the computational load of the reflected sound for which selection was determined to the total computational load (S208).

Then, when the total computational load exceeds the computational load upper limit (“Yes” in S209), selector 1302 determines that the remaining unassessed reflected sounds are reflected sounds that are not to be selected, and ends the selection processing. In this case, selector 1302 may make a redetermination that the reflected sound for which selection was determined last is not to be selected. This makes it possible to control the total computational load to be less than or equal to the computational load upper limit.

The processes starting with the selection processing are not applied to the reflected sounds that were determined to be reflected sounds that are not to be selected. In other words, it is determined that the remaining reflected sounds will not be generated.

If there are reflected sounds, among the reflected sounds extracted as the selection candidates, for which selection or non-selection is yet undetermined (“Yes” in S210), selector 1302 repeats the processing (S207 to S209), and if there are no undetermined reflected sounds (“No” in S210), selector 1302 ends the selection processing.

Furthermore, a reflected sound selected may be subjected to processing involving decreasing, by a predetermined amount, the level of importance of the sound source object and the reflection object that generate the reflected sound (S211).

When reflected sounds originating from sound source objects and reflection objects are selected, this makes it more difficult for a different unassessed reflected sound originating from the same sound source object or the same reflection object to be selected in the next selection processing. To put it differently, when no reflected sounds originating from a sound source object or a reflection object are selected, this makes it easier for a reflected sound originating from the sound source object or the reflection object to be selected in the next selection processing.

As a result, the selection of only reflected sounds originating from a specific sound source object or reflection object is inhibited. Consequently, the presence of only a specific sound source object or reflection object in a sound space increasing and the presence of other sound source objects or reflection objects being lost is inhibited.

In other words, when a certain reflected sound has been selected, the value of the “sound source” for that reflected sound may be reduced. This makes it easier for a reflected sound pertaining to another sound source to be selected in the next turn. Furthermore, when a certain reflected sound has been selected, the value of the “wall” (reflection object) that has generated that reflected sound may be reduced. This makes it easier for a reflected sound generated by another wall to be selected in the next turn.

For example, when three sound sources (direct sounds) are present in a cube-shaped room, logically 18 reflected sounds (3 sounds×6 surfaces) are generated. However, generating, in a sound space, all of the reflected sounds that would logically be generated is difficult due to the issue of computational load. When it is difficult to select all 18 reflected sounds, the reflected sounds are selected so as to reflect the influence of the three “sound sources” and the six “walls” evenly and without bias. This makes it possible to reduce the amount of computation for generating the reflected sounds, while maintaining the presence of the three “sound sources” and the six “walls”.

In the above-described example, for example, the sound source objects are expressed as X, Y, and Z, the walls are expressed as R1 to R6, and the reflected sounds are expressed as x1 to x6, y1 to y6, and z1 to z6. Despite the amount of computation only being sufficient to generate six reflected sounds, when the reflected sounds of x1 to x6 are selected, the presence of sound source objects Y and Z in the sound space becomes scarce.

Furthermore, when the six reflected sounds of x1, y1, z1, x2, y2, and z2 are selected, the tangibility of walls R3 to R6 in the sound space fails to be reproduced. On the other hand, in the case of, for example, the sound volume of sound source Y being near zero, it is not very important to express the tangibility of sound source Y. Thus, the evaluation values of reflected sounds y1 to y6 may be low. In this way, with regard to which reflected sounds to select in the context of the computation resources being constrained, the reflected sounds may, instead of being selected randomly, be selected evenly based on the level of importance in terms of acoustic, auditory, and visual viewpoints.

Note that the method for determining the reflected sounds to be selected is not limited to a method of making determinations in order, from the reflected sound having the highest evaluation value. For example, reflected sounds having evaluation values greater than or equal to the threshold value, and reflected sounds having evaluation values of less than the threshold value may not be selected. Furthermore, reflected sounds having evaluation values in a higher tier may be selected at a predetermined proportion. Alternatively, selection of reflected sounds having evaluation values in a lower tier may be skipped at a predetermined proportion. In these cases, the loop processing of sequentially adding the computational loads of the reflected sounds may not be performed.

### Evaluation Processing

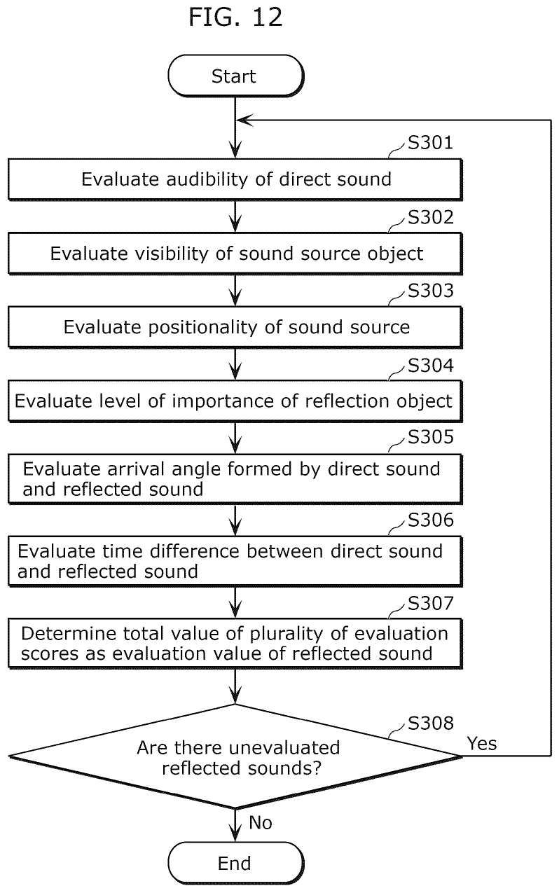

FIG. 12 is a flowchart for illustrating an example of evaluation processing. The specific method for determining evaluation values will be described with reference to the flowchart illustrated in FIG. 12.

Selector 1302 may calculate an evaluation value for each reflected sound by an evaluation method set beforehand based on, for example, the sound volume of the sound source, the visual properties of the sound source, the positionality of the sound source, the visual properties of the reflection object (the obstacle object), the geometrical relationship between a direct sound and the reflected sound, and/or the like.

Specifically, selector 1302 obtains a plurality of reflected sounds each extracted as a selection candidate, and calculates, for each reflected sound of the plurality of reflected sounds, the evaluation value of the reflected sound, based on the sensory level of importance of the reflected sound.

For example, evaluation scores may be assigned to the reflected sounds based on each of the plurality of indicators described below, and the reflected sounds may each be assigned an evaluation value based on the evaluation scores. Of course, the plurality of indicators for evaluation are not limited to the plurality of indicators described below. Furthermore, any one of the plurality of indicators may be used, two or more of the plurality of indicators may be used, or all of the plurality of indicators may be used. Moreover, the evaluation order regarding the plurality of indicators may be determined based on a predetermined order of priority of the indicators.

### Evaluation Score Calculation

Specifically, an indicator regarding sound source objects may be used as an indicator for evaluating reflected sounds. Furthermore, when, as described above, a reflected sound originating from a sound source object is selected, the value of that sound source object may be reduced. This makes it possible to evenly reproduce reflected sounds originating from a greater number of sound source objects, without a bias toward reflected sounds originating from a specific sound source object. Thus, it is possible to secure hints that allow the listener to correctly perceive the positions of individual sound sources.

For example, when, from 300 reflected sounds originating from 10 sound sources, 30 reflected sounds are selected, selecting 30 reflected sounds that originate from a specific sound source would make it difficult to perceive the positioning of other sound sources. Further, it is not necessarily the case that allocating 3 reflected sounds to each of the 10 sound sources would be optimal. Thus, an evaluation score may be assigned to reflected sounds originating from a sound source object based on the level of importance of the sound source object or the level of importance of the direct sound emitted from the sound source object.

For example, as described later, the level of importance of a sound source object, or in other words the level of importance of a direct sound, may be evaluated based on the audibility of the direct sound or the visibility of the sound source object. That evaluation may be used as the evaluation of the reflected sounds originating from the direct sound generated from that sound source object. In other words, an evaluation score of an indicator regarding sound source objects may be assigned to reflected sounds based on the audibility of a direct sound or the visibility of a sound source object.

Furthermore, it goes without saying that evaluations of sound source objects and direct sounds may be used not only for selecting reflected sounds, but also for selecting direct sounds.

Selector 1302 may evaluate a sound source object based on the audibility, i.e., the ease of hearing, a direct sound, and that evaluation may be used as an evaluation indicator for reflected sounds (S301). For example, evaluation score A, obtained by evaluating audibility by using information on the magnitude of a direct sound, may be assigned to a sound source object (direct sound) and reflected sounds.

Specifically, a high point value in evaluation score A may be assigned to a sound source object having high sound volume, in comparison to a sound source object having low sound volume. Similarly, a high point value for evaluation score A may be assigned to a reflected sound originating from a sound source object having high sound volume, in comparison to a reflected sound originating from a sound source object having low sound volume.

Note that since the magnitude of a sound is generally determined by sound volume or amplitude value, it goes without saying that the amplitude value may be used instead of sound volume. In other words, information regarding the magnitude of a sound may be sound volume (decibel value), or may be amplitude value. Since the sound volume or amplitude value of a sound generally changes with each passing moment, it goes without saying that information on the magnitude of a sound used for evaluation may be a reference sound volume assigned to a sound source object, or may be information indicating the transitioning magnitude of a sound over a temporal period.

Note that both the information on reference sound volume and the information on transitioning sound volume over a temporal period may be used as the information indicating the magnitude of a direct sound. For example, the evaluation score for a direct sound may be calculated by, after an evaluation score for a sound source object has been calculated based on the information on reference sound volume, correcting the evaluation score by using the information indicating the transitioning magnitude of the sound. Of course, the evaluation score for a direct sound may be corrected by using the reference sound volume assigned to a sound source object, after first calculating an evaluation score for the direct sound by using the information indicating the transitioning magnitude of the sound.

Furthermore, the evaluation score for a sound source object (direct sound) may be calculated by using only one of the information on reference sound volume or the information on the transitioning sound volume over a temporal period.

For example, when the virtual space is a virtual conference room and the direct sound is a speaking voice, the sound volume transitions intermittently over short periods of time. In other words, sound portions and silent portions occur alternately. Furthermore, when the virtual space is a concert hall and the direct sound is the performance of a musical piece, the sound volume is maintained over a certain duration of time. Moreover, when the virtual space is a battlefield and the direct sound is an explosion sound, the sound volume becomes large for only an instant and then continues to be silent or in a quiet state thereafter.

In this way, the sound volume information of the sound source may include not only information on the magnitude of sound but also information on the transition of sound magnitude. For example, the information may be information in which a plurality of sets that include durations of time in which the sound volume is essentially a constant value and sound volume values corresponding to those time intervals are enumerated in chronological order.

Furthermore, efforts to use temporal transitions in the frequency characteristics of signals for the acoustic processing of virtual spaces have been conventionally widely performed (PTL 1, etc.). When considering such conventional techniques, it goes without saying that the above-described sets may be sets that include durations of time in which the frequency characteristics are constant and those frequency characteristics.

Selector 1302 may evaluate a sound source object by visibility, and that evaluation may be used as an evaluation indicator for reflected sounds (S302).

Specifically, selector 1302 may detect a sound source object visible to the listener in video provided from a video-providing device in synchronization with a sound provided from audio presentation device 1002.

In other words, the sound source object included in the video provided from the video-providing device in synchronization with the sound provided from audio presentation device 1002 may be detected as a visible sound source object. The assessment of visibility may be performed in accordance with update processing of the spatial information managed by the spatial information manager (1201, 1211), i.e., in accordance with processing in an information update thread.

Moreover, selector 1302 may assign a high point value in evaluation score V to sound source objects detected as visible objects, in comparison to sound source objects that are not visible to the listener.

Similarly, selector 1302 may assign a high point value in evaluation score V to direct sounds and reflected sounds that originate from sound source objects that are visible to the listener, in comparison to direct sounds and reflected sounds that originate from sound source objects that are not visible the listener.

Furthermore, the method for detecting objects visible to the listener is not limited to a method based on video provided in synchronization with a sound, such as that described above. For example, visible objects may be determined based on the relationship between the position of the listener and the position of the object in the sound space.

In other words, when, based on the spatial information managed by the spatial information manager (1201, 1211), there is no obstacle object that acts as an obstruction between the position of the listener and the position of the sound source object, it may be specified that the sound source object is visible to the listener. More specifically, when no obstacle object is present in the propagation paths of direct sounds and reflected sounds that are calculated by analyzer 1301 and can be generated in the sound space, it may be specified that a sound source object or a reflected object is visible to the listener.

Alternatively, it may be specified that a sound source object positioned within a predetermined distance range from the position of the listener is visible to the listener.

Moreover, selector 1302 may evaluate the importance of a reflected sound originating from a sound generated from a sound source object specified to be visible to the listener to be high, and may assign such a reflected sound a high evaluation score V.

Using the visibility of sound source objects as an indicator makes it possible to appropriately select reflected sounds such that the visual positioning in a video and the auditory positioning (acoustic positioning) in acoustics match each other. When the visual positioning of sound source objects visible to the listener and the acoustic positioning based on direct sounds and reflected sounds provided from audio presentation device 1002 and their relationship do not match, the sense of positionality becomes unnatural, the listener senses incongruity, and the sense of immersion is reduced.

On the other hand, even if the acoustic positioning corresponding to a sound source object that is not visible diverges to some degree from the proper positioning, there is little sense of incongruity. Thus, the evaluation score V of reflected sounds originating from sound source objects that are not visible may be low.

Note that audio presentation device 1002 and the video-providing device may be the same device, as in VR goggles and a head-mounted display, or may be separate devices, as in earphones and a smartphone.

Selector 1302 may evaluate a sound source object based on positionality, and that evaluation may be used as an evaluation indicator for reflected sounds (S303).

Specifically, selector 1302 may detect the moving speed of a sound source object visible to the listener that is in video provided from a video-providing device in synchronization with a sound provided from audio presentation device 1002. Furthermore, selector 1302 may assign a high evaluation score S to a sound source object having a slow moving speed, in comparison to a sound source object having a fast moving speed. Similarly, selector 1302 may assign a high evaluation score S to direct sounds and reflected sounds originating from a sound source object having a low moving speed, in comparison to direct sounds and reflected sounds originating from a sound source object having a high moving speed.

Furthermore, when a sound source object is stopped, selector 1302 may assign the highest evaluation score S to direct sounds and reflected sounds originating from the sound source object, in the indicator of the positionality of the sound source object. For example, selector 1302 may assign a higher evaluation score to a reflected sound originating from a sound emitted from a stopped sound source object than to a reflected sound originating from a sound emitted from a moving sound source object.

Furthermore, for example, selector 1302 may assign higher evaluation scores to direct sounds and reflected sounds originating from sound source objects as the moving speeds of the sound source objects are slower.

Visual positioning and the direction of arrival of direct sounds are dominant in the positioning of fast-moving sound sources. Thus, selector 1302 may assign a low evaluation score to a reflected sound corresponding to a fast-moving sound source, such that the reflected sound is not selected.

Using the positionality of sound source objects as an indicator makes it possible to appropriately select reflected sounds such that visual positioning and acoustic positioning match. This makes it possible to inhibit the sense of positionality from feeling unnatural due to a mismatch between the visual positioning and the acoustic positioning.

Selector 1302 may use the level of importance of reflection objects as a reflected sound evaluation indicator. In other words, selector 1302 may evaluate the level of importance of reflection objects (S304).

For example, information on reflection objects may be included in the spatial information. Furthermore, selector 1302 may evaluate the level of importance of reflection objects based on the information on reflection objects. Moreover, selector 1302 may assign evaluation scores to reflected sounds originating from a reflection object, based on the level of importance of the reflected object.

For example, selector 1302 may assess the level of importance of reflection objects based on the information included in the input signal or the metadata included in the bitstream. Furthermore, selector 1302 may assess the level of importance of reflection objects based on other flags, parameters, or the like included in the input signal.

For example, the level of importance of a reflection object may be specified based on, e.g., visual characteristics of the reflection object (obstacle object), information on the material of the reflection object, or the like. For example, the level of importance may be assessed to be high in accordance with visual characteristics of the reflection object (obstacle object), i.e., for a sound source object that is visible to the listener.

Specifically, a reflection object (obstacle object) that is visible to the listener may be detected in video provided from the video-providing device in synchronization with a sound provided from audio presentation device 1002. Moreover, selector 1302 may assign a high level of importance to that reflection object, which was detected as a visible object, in comparison to a reflection object that is not visible to the listener.

Similarly, selector 1302 may assign a high point value in evaluation score V to a reflected sound originating from a reflection object that is visible to the listener, in comparison to a reflected sound originating from a reflection object that is not visible to the listener. In other words, selector 1302 may highly evaluate the level of importance of a reflected sound originating from a reflection object that is in the visual field of the listener, and assign a high evaluation score V to such a reflected sound.

Note as that the method for detecting reflection objects visible to the listener, a method similar to the method for detecting visible sound source objects, described above, can be used.

Here, a method that involves using information on the material of a reflection object as an evaluation indicator for the sensory level of importance of reflected sounds will be described. For example, as information on the material of a reflection object, a plurality of parameters such as a reflection coefficient (reflectance), diffusivity, transmittance, sound absorbance rate, and/or the like may be obtained from the metadata. Furthermore, the sensory level of importance of reflected sounds may be evaluated in accordance with the proportions of each of the parameters.

Specifically, when, of a plurality of parameters regarding materials that can be set for reflection surfaces of reflection objects, the proportion of the reflectance or the diffusivity is high, the sound volume of reflected sounds that are reflected by the reflection surface to arrive at the listener increases in comparison to when the proportion of the transmittance or sound absorbance rate is high. In this case, it is likely for the sensory level of importance to increase. Thus, when, of a plurality of parameters regarding a material that is set for a reflection surface of a reflection object, the proportion of the reflectance or the diffusivity is high, the evaluation value may be high for reflected sounds that are reflected by that reflection object.

Furthermore, information on the material of a reflection object is not limited to being the reflection coefficient (reflectance), diffusivity, transmittance, sound absorbance rate, and the like, and may be information that makes it possible to specify the level of importance of a material. For example, a set of a plurality of parameters such as the reflection coefficient (reflectance), diffusivity, transmittance, sound absorbance rate, and the like may be obtained from the metadata as information for specifying a material. Furthermore, the level of importance may be predefined for each material identifier. The evaluation value of a reflected sound may then be calculated in accordance with the level of importance tied to a material identifier.

Furthermore, it is not necessary for all of the plurality of parameters to be considered; the level of importance of the material of a reflection object may be specified using only a part of the parameters.

Moreover, information for specifying (identifying) materials is not limited to information for unambiguously discriminating between materials (material identification information), and may be, for example, material that classifies materials (material classification information). Information that classifies materials may be, for example, information in which classification is performed by a classification method set beforehand by the content creator.

Using the level of importance of reflection objects as an indicator makes it possible to appropriately select reflected sounds originating from reflection objects having a high level of importance, based on the levels of importance of the reflection objects.

Furthermore, when a reflected sound originating from a reflection object has been selected, the level of importance of the reflection object may be updated to be low. This makes it possible to evenly reproduce reflected sounds originating from a greater number of reflection objects, without bias toward reflected sounds originating from a specific reflection object (for example, a specific wall or a specific ceiling). Thus, it is possible to secure hints that allow the listener to correctly perceive the size of the sound space.

For example, when selecting 30 reflected sounds from 300 reflected sounds emitted in a sound space, selecting 30 reflected sounds reflected from a specific wall surface would make it difficult to grasp the entire space. Further, it is not necessarily the case that allocating 5 reflected sounds to each of the 6 wall surfaces would be optimal. Thus, as described above, control may be performed to determine whether to select reflected sounds originating from each reflection object (for example, walls), based on the value (level of importance) of the reflection object.

Selector 1302 may use the relationship (for example, the geometrical relationship) between a direct sound and a reflected sound as a reflected sound evaluation indicator. Specifically, selector 1302 may evaluate the geometrical relationship between a direct sound and a reflected sound by means of the arrival angle formed by the direct sound and the reflected sound, and use that evaluation as a reflected sound evaluation indicator (S305). Here, the arrival angle formed by the direct sound and the reflected sound corresponds to the angle formed by the direction of arrival of the direct sound and the direction of arrival of the reflected sound, and corresponds to an angular difference between the angle of the direction of arrival of the direct sound with respect to a reference direction and the angle of the direction of arrival of the reflected sound with respect to the reference direction.

The angle formed by the direction of arrival of the direct sound and the direction of arrival of the reflected sound may be detected, and a higher evaluation score may be assigned to the reflected sound as the angle is larger.

For example, analyzer 1301 calculates a direct sound arrival path (pd) and a reflected sound arrival direction path (pr). Analyzer 1301 or analyzer 1302 calculates the direction of arrival of the direct sound and the direction of arrival of the reflected sound by using the direct sound arrival path (pd), the reflected sound arrival direction path (pr), and orientation information (D) of the avatar (the listener) included in the input signal. The direction of arrival of the direct sound and the direction of arrival of the reflected sound are expressed using the orientation of the listener as a reference.

Moreover, selector 1302 calculates the evaluation score for the reflected sound based on the angle formed by the direction of arrival of the direct sound and the direction of arrival of the reflected sound.

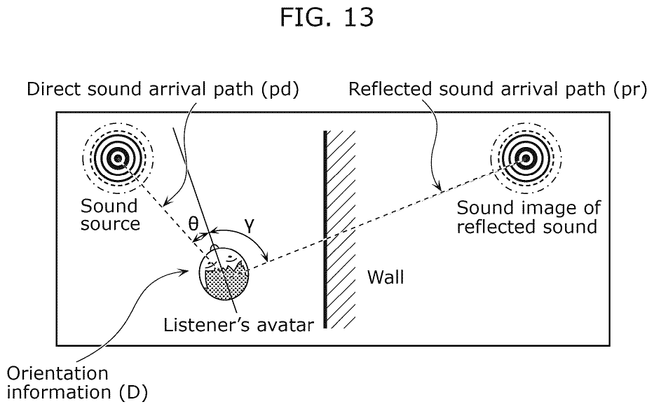

FIG. 13 is a diagram for illustrating an example of the arrival angle between a direct sound and a reflected sound. For example, as in FIG. 13, an avatar, a sound source object, and an obstacle object are positioned. Position information of the avatar, the sound source object, and the obstacle object, as well as orientation information (D) of the avatar, are obtained from the input signal. Furthermore, from these items of information, the orientation of the avatar is judged to be 0 degrees, and the direct sound direction (θ) and the direction of the sound image of the reflected sound (γ) are calculated.

In the case of FIG. 13, the direction of the direct sound (θ) is about 20 degrees, and the direction of the sound image of the reflected sound (γ) is about 265 degrees (−95 degrees). In this case, the angle formed by the direction of arrival of the direct sound and the direction of arrival of the reflected sound is about 115 degrees.

When the angle formed by the direction of arrival of the direct sound and the direction of arrival of the reflected sound is large, a high evaluation score is assigned to the reflected sound. In this way, for example, a reflected sound that originates from a sound emitted from a sound source visible in the front of the listener and that is audible behind the listener receives a high evaluation score. As a result, it is possible to preferentially select reflected sounds that contribute to the listener anticipating the presence of a large object to the rear, whereby it is possible to produce a feeling of entrapment and tension.

Selector 1302 may evaluate the relationship between a direct sound and a reflected sound by using a time difference between the direct sound and the reflected sound, and may use that evaluation as a reflected sound evaluation indicator (S306). For example, selector 1302 may assign a higher evaluation score to a reflected sound for which the difference in the arrival time period between the direct sound and the reflected sound is large, than to a reflected sound for which the difference in the arrival time period is small. For example, the echo that comes back when yelling “yahoo” from a mountaintop definitively affects the grasping of the space. Thus, a high evaluation score may be assigned to such a reflected sound.

Selector 1302 may evaluate the relationship between a direct sound and a reflected sound by means of the time difference between the direct sound and the reflected sound, and a threshold value corresponding to the time difference. For example, a reflected sound that arrives at the position of the listener immediately after a direct sound is susceptible to masking by the direct sound, and is difficult to perceive. On the other hand, a reflected sound that arrives at the position of the listener with a time difference from the direct sound is less susceptible to masking by the direct sound, and is easier to perceive. Evaluation scores may be assigned to reflected sounds based on such a sensory model.

The time difference (T) between a direct sound and a reflected sound may be, for example, a time difference between the time periods taken when each of the direct sound and the reflected sound arrive at the listener. For example, the difference (T) between the time periods taken when each of a direct sound and a reflected sound arrive at the listener can be determined by T=tr−td.

For example, when a reflected sound is evaluated by using the relationship between the direct sound and the reflected sound, comparison processing is performed using a threshold value determined in accordance with the time difference between the direct sound and the reflected sound. The threshold value indicates a preset sound volume that corresponds to the time difference between the direct sound and the reflected sound, and is decided with reference to threshold value data. An indicator that indicates a boundary demarcating whether a reflected sound corresponding to a direct sound is perceived by the listener may be used as the threshold value data.

For example, the threshold value indicates a value that expresses, e.g., a numerical value determined in accordance with the time difference (T), and the threshold value data indicates table data or a relational expression used to specify or calculate the threshold value at the time difference (T). However, the format and type of the threshold value data are not limited to table data or a relational expression.

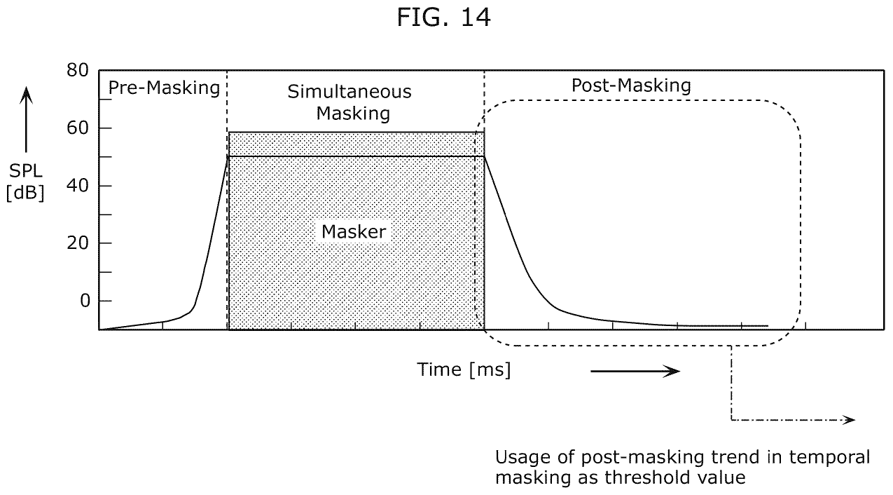

FIG. 14 is a diagram for illustrating an example of a method for setting threshold value data based on a temporal masking phenomenon. For example, the threshold value data may be set with reference to a masking threshold value that is a known threshold value. As disclosed in NPL 1 and the like, the temporal masking phenomenon is widely known. The shaded portion in the drawing indicates the amplitude of and the time period during which a masker (an inhibitory signal that obstructs the sensing of signal S, which is a target to be heard) is generated.

In FIG. 14, the masking threshold value indicates the level (SPL: sound pressure level) at which signal S can be heard. Naturally, while the masker is being generated, the masking threshold value is high. On the other hand, even after the masker has stopped, the masking threshold value does not instantly reach zero, but gradually attenuates. In other words, directly after the masker has stopped, for some time (the period of time during which post-masking is present), the masking threshold value is high.

For example, the trend of the post-masking, indicating in FIG. 14 by the area enclosed by the dotted line, may be used as threshold value data for evaluating a reflected sound based on the relationship between the direct sound and the reflected sound. In other words, it may be considered that the direct sound corresponds to the masker and the reflected sound corresponds to signal S, which is the target to be heard, and the threshold value data may be determined based on the post-masking trend.

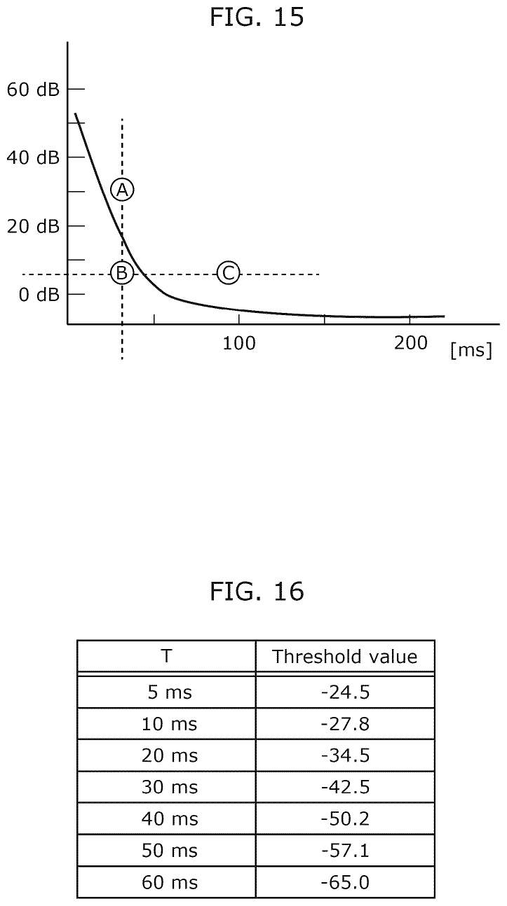

FIG. 15 is a diagram for illustrating an example of threshold value data. In the above-described case, the threshold value data may be set as in the curved line illustrated in FIG. 15. In FIG. 15, in a graph having a horizontal axis that indicates the time difference between a direct sound and reflected sounds and a vertical axis that indicates the sound volume of the reflected sounds, the curved line illustrates the boundary (threshold value) that demarcates whether each reflected sound is perceived. The curved line corresponds to the threshold value data.

Note that the threshold value data pertaining to the present embodiment is stored in memory 1404 of audio signal processing device 1001. The format and type of the threshold value data to be stored may be in any format and type. For example, the threshold value data may be expressed as an approximation formula that includes the time difference between a direct sound and a reflected sound as a variable. Alternatively, the threshold value data may be expressed as an arrangement of time differences between a direct sound and a reflected sound, and threshold values.

FIG. 16 is a diagram for illustrating relationships between time differences between direct sounds and reflected sounds, and threshold values. As illustrated in FIG. 16, the threshold value data may be stored in a region of memory 1404 as an arrangement that includes an index of time differences between a direct sound and a reflected sound and threshold values that correspond to the index.

Of course, the graphs and numerical values illustrated in FIG. 15 and FIG. 16 are examples, and the threshold value data is not limited thereto.

Information on a relational expression that indicates the relationship between time differences (T) and threshold values may be stored in memory 1404. In other words, an expression that includes the time difference (T) as a variable may be stored. The threshold values of the time differences (T) may be approximated by a straight line or a curved line, and a parameter that indicates the geometrical shape of the straight line or the curved line may be stored. For example, when the geometrical shape is a straight line, the start point and the slope for expressing the straight line may be stored.

When threshold values having a plurality of formats and types are stored, the format and the type of the threshold value to be used may be decided in the selection processing for reflected sounds.

Furthermore, the threshold values for evaluating reflected sounds are not limited to known masking threshold values. Other threshold values may be determined in relation to time differences between direct sounds and reflected sounds, and values indicating an amplitude value or sound volume. For example, threshold values may be determined based on the minimum time difference at which the listener's perception detects the divergence of two sounds. Specific numerical values may be derived from research results that are already known, or may be determined by an auditory test performed with the premise of application in the virtual space.

For example, threshold values may be set based on time differences between the arrival time of a direct sound and the arrival time of a reflected sound, with reference to threshold value data. When the arrival time sound volume of a reflected sound is higher than the threshold value set, selector 1302 may assign a high evaluation score.

To put it differently, the time difference between the arrival time of a direct sound and the arrival time of a reflected sound is the difference in the amount of time taken for the direct sound and the reflected sound to arrive at a listening position. Thus, the distance difference between the arrival path of the direct sound and the arrival path of the reflected sound may be used as a value pertaining to the time difference between the arrival time of the direct sound and the arrival time of the reflected sound.

Furthermore, the time difference between the time point at which the emission of the direct sound ends and the time point at which the reflected sound arrives at the listening position may be used as the time difference between the direct sound and the reflected sound. Here, the ending time of the direct sound may be determined by, for example, adding the duration of the direct sound to the arrival time of the direct sound.

Referring to FIG. 9 and FIG. 10, which illustrate the positional relationship between the listener and the obstacle object, and FIG. 15, which illustrates an example of the threshold value data, a method for evaluating reflected sounds using threshold value data will be described.

The graph in FIG. 15 has a horizontal axis that indicates the time difference between a direct sound and reflected sounds, and a vertical axis that indicates the sound volume ratio of the reflected sounds to the direct sound. The curved line expresses the threshold value that is the boundary that demarcates whether each reflected sound is perceived. A, B, and C in the graph each indicate a reflected sound. Note that here, the sound volume ratio, i.e., the sound volume of each reflected sound determined in relation to the sound volume of the direct sound, is used, but the sound volume of each reflected sound determined absolutely, without reference to the sound volume of the direct sound, may be used.

Note that it goes without saying that when the sound volume is expressed in units of decibels on a logarithmic scale (when the sound volume is expressed in the decibel domain), the sound volume ratio between the two signals is expressed as a decibel value difference. Specifically, the sound volume ratio between the two signals may be the difference when the amplitude value of each signal is expressed in the decibel domain. That value may be calculated based on, e.g., an energy value, a power value, or the like. Furthermore, this difference can be referred to as a difference in gain or simply a gain difference, in the decibel domain.

In other words, the sound volume ratio in the present disclosure is essentially the ratio between the amplitudes of signals; thus, the sound volume ratio may be expressed as a loudness ratio, a volume ratio, an amplitude ratio, a sound level ratio, a sound intensity ratio, a gain ratio, or the like. Furthermore, when the unit of sound volume is decibels, it goes without saying that the sound volume ratio in the present disclosure may be rephrased as the sound volume difference.

In the present disclosure, the “sound volume ratio” typically means the gain difference when the sound volume of each of two sounds is expressed in the unit of decibels, and in the examples of the embodiment, the threshold value data is also typically specified by the gain difference expressed in the decibel domain. However, the sound volume ratio is not limited to the gain difference in the decibel domain. When a sound volume ratio that is not expressed by the decibel domain is used, threshold value data specified in the decibel domain may be used by converting the threshold value data into the unit of the sound volume ratio calculated. Alternatively, threshold value data specified beforehand in each unit may be stored in the memory.

In other words, for example, even if a ratio between energy values, power values, or the like is used instead of the sound volume ratio, it is obvious that the algorithm in the present disclosure can be applied to solve the problem of the present disclosure.

FIG. 9 illustrates the positional relationship between the listener, a sound source object, and an obstacle object (a wall). In FIG. 9, the sound source object and the obstacle object are comparatively far from each other, and reflected sound C in FIG. 15 is heard by the listener. FIG. 10 illustrates another positional relationship between the listener, a sound source object, and an obstacle object (a wall). In FIG. 10, the sound source object and the obstacle object are comparatively close to each other, and reflected sound A or B in FIG. 15 is heard by the listener.

For example, as shown in FIG. 9, when the listener and the obstacle object are comparatively far from each other, the arrival time period of the reflected sound becomes longer, and for reflected sound C, compared to reflected sound A or B, the time difference between the direct sound and the reflected sound increases.

In other words, as illustrated in FIG. 15, reflected sound C is positioned further on the right side of the graph relative to reflected sound A or B. As in the curved line in the graph, the threshold value decreases as the time difference between the direct sound and the reflected sound is greater. As a result, reflected sound B, the sound volume of which is the same as the sound volume of reflected sound C, is lower than the threshold value, and reflected sound C is higher than the threshold value. Thus, the evaluation score for reflected sound C is higher than the evaluation score for reflected sound B.

Furthermore, reflected sounds A and B have the same arrival time period, but the sound volume of reflected sound A is greater than the sound volume of reflected sound B, and the sound volume of reflected sound B is less than the sound volume of reflected sound A. Moreover, the sound volume of reflected sound A is greater than the threshold value illustrated by the curved line, and the sound volume of reflected sound B is less than the threshold value illustrated by the curved line. In this case, a higher evaluation score is assigned to reflected sound A than to reflected sound B.

The reflected sound evaluation is performed based on the threshold value indicating the sound volume, determined based on the time difference between a direct sound and a reflected sound. Accordingly, the nature of human perception, in which a reflected sound that arrives at the position of the listener after a time difference from a direct sound is easy to perceive due to not being masked by the direct sound, is reflected in the reflected sound evaluation.

Using the threshold value indicating sound volume that is determined based on the time difference between a direct sound and a reflected sound makes it possible to more appropriately select reflected sounds that have a greater impact on the listener's perception, compared to using only the time difference between a direct sound and a reflected sound or the sound volume of a reflected sound.

Furthermore, the calculation of the arrival time period and the arrival time sound volume of direct sounds and reflected sounds may be omitted, and reflected sounds may be evaluated based on path length. When reflected sounds are evaluated based on the path length at the time of each of the direct sound and the reflected sound arriving at the listener, the threshold value of the path length of the reflected sound may be set in accordance with the value of the path length difference. In that case, reflected sounds may be evaluated on whether the path length of the reflected sound is greater than the threshold value determined in accordance with the value of the path length difference.

When the selection processing is performed based on the path length, it is possible to perform the selection processing based on information that has an impact on the time difference, while reducing the amount of computation in comparison to performing the selection processing based on the time difference. Furthermore, a parameter that indicates sound propagation speed or a parameter that has an impact on the sound propagation speed parameter may be used in addition to the path length difference.

The geometrical relationships may be positional relationships between a sound source, the listener, and a reflection object in a virtual space. The path lengths of each of the direct sound and the reflected sound arriving can be geometrically calculated based on these relationships. Therefore, using the relationship that sound volume is inversely proportional to distance, it is possible to calculate the reference sound volume of a reflected sound with respect to the reference sound volume of a direct sound.

A reflection coefficient of the reflection object may be used for calculation of the reference sound volume of a reflected sound. Furthermore, a generally used typical value may be used as the reflection coefficient. On the other hand, when special conditions are present, such as the reflection object being covered by a sound-absorbing material or the like, a specially assigned reflection coefficient may be used as the reflection coefficient of the reflection object.

Each reflected sound may be evaluated based on the sound volume of the reflected sound. The sound volume of the reflected sound may, as described above, be determined from the geometrical relationship between the direct sound and the reflected sound, and an indicator assigned to the reflection object. The reflected sound may be evaluated by comparing that sound volume with a predetermined threshold value.

Furthermore, information that indicates a temporal transition in the sound volume of the sound source may be reflected in the evaluation. For example, in a case in which the information that indicates a temporal transition in the sound volume of the sound source indicates the duration of a sound interval, the reflected sound evaluation value may be maintained as-is when the time is within the sound interval. On the other hand, when the time is outside of the sound interval, processing to reduce or make zero the evaluation value of the reflected sound may be performed, even if the reference sound volume of the reflected sound exceeds the threshold value.

Alternatively, the information that indicates a temporal transition in the sound volume of the sound source may be data that lists, in chronological order, a plurality of sets of a duration for which it is considered that the amplitude of the sound signal is largely constant and amplitude values of the signal during that period. In that case, processing may be performed such that reflected sounds are evaluated by changing the reference sound volume of the reflected sounds in coordination with changes in the amplitude values in the data.

Note that evaluation scores pertaining to all of the above-described indicators may be assigned to one reflected sound, or evaluation scores pertaining to a part of the indicators may be assigned. Furthermore, the number of indicators used for evaluation may be different for each reflected sound, or the same indicators may be used for all of the reflected sounds. Determination of which indicators to use when assigning evaluation scores to reflected sounds may be set based on predetermined information, and for example, this may be decided based on information contained in the input signal, or may be decided based on information set by the listener or the manager.

Furthermore, an evaluation score being high corresponds to the evaluation score being large, and an evaluation score being low corresponds to the evaluation score being small. Similarly, the evaluation value being high corresponds to the evaluation value being large, and the evaluation value being low corresponds to the evaluation value being small. These expressions may be mutually interchangeable.

### Calculation of Evaluation Values

Next, selector 1302 calculates, for a reflected sound to which evaluation scores have been assigned using the indicators, an evaluation value that indicates the level of importance of the reflected sound, based on the evaluation scores. For example, selector 1302 determines the total value of a plurality of evaluation scores as the evaluation value of a reflected sound (S307). The total value of a plurality of evaluation scores may be a weighted total value. If there are unevaluated reflected sounds (“Yes” in S308), selector 1302 repeats the above-described processing (S301 to S307), and if there are no unevaluated reflected sounds (“No” in S308), the evaluation processing is ended.

Note that the evaluation value of a reflected sound is not limited to being the total value of a plurality of evaluation scores obtained from a plurality of indicators. For example, a predetermined reference evaluation value and an already calculated evaluation value may be corrected by a plurality of evaluation scores. Furthermore, evaluation scores from only a part of indicators may be used for the evaluation value of a reflected sound, or may be used for correction of the evaluation value of a reflected sound. Moreover, when a plurality of evaluation scores are assigned to one reflected sound based on a plurality of indicators, the highest evaluation score may be decided as the evaluation value of the reflected sound.

Which indicator evaluation scores to use for calculation or correction of the evaluation value may be decided based on predetermined information, may be decided based on information contained in the input signal, or may be decided based on information set by the listener or the manager.

Note that in the above description, the evaluation scores and the evaluation values may be divided, for convenience, into evaluation scores obtained based on indicators, and evaluation values obtained using a plurality of evaluation scores that are obtained based on a plurality of indicators. However, since both of these indicate evaluation results for reflected sounds, the evaluation scores and the evaluation values may be treated as the same. Furthermore, audio signal processing device 1001 may use the evaluation score obtained based on one indicator as-is as the evaluation value for selection processing of reflected sounds, or may use a plurality of evaluation scores obtained based on a plurality of indicators for selection processing of reflected sounds.

For example, when a plurality of evaluation scores are used for selection processing of reflected sounds, audio signal processing device 1001 assesses whether to select reflected sounds based on each of the plurality of evaluation scores. When the plurality of assessment results based on the plurality of evaluation scores all indicate that a reflected sound is to be selected, audio signal processing device 1001 may finally assess that the reflected sound is to be selected. Alternatively, when any one of the plurality of assessment results based on the plurality of evaluation scores indicates that a reflected sound is to be selected, audio signal processing device 1001 may finally assess that the reflected sound is to be selected.

Furthermore, levels of priority may be set for a plurality of evaluation scores based on a plurality of indicators. For example, audio signal processing device 1001 may assess whether to select a reflected sound based on each of first to third evaluation scores based on first to third indicators.

In the above-described case, when the assessment result based on the first evaluation score indicates that a reflected sound is not to be selected, audio signal processing device 1001 makes a final assessment that the reflected sound is not to be selected, without depending on the assessment results based on the second and third evaluation scores.

Furthermore, when the assessment result based on the first and second evaluation scores indicate that a reflected sound is to be selected, audio signal processing device 1001 makes a final assessment that the reflected sound is to be selected, without depending on the assessment result based on the third evaluation score.

For example, after determination of the evaluation value of a reflected sound, processing is performed as described above, following the flowchart illustrated in FIG. 11.

### Order and Omission of Processes

A part of the processes included in the flowcharts illustrated in FIG. 11 and FIG. 12 may be omitted, and the order of the processes may be changed.

For example, in the flowchart illustrated in FIG. 11, selection processing of reflected sounds may be performed based on both the computational load and the evaluation values (levels of importance) of the reflected sounds. However, selection processing of reflected sounds may be performed based on only one of these.

Specifically, when, for each reflected sound, the calculation of the evaluation value of the reflected sound is omitted and the computational load of the reflected sound is higher than the threshold value, selector 1302 may assess that the reflected sound is not to be selected. Alternatively, selector 1302 may perform selection processing of a reflected sound based on only the evaluation value of the reflected sound, omitting the obtaining of information indicating the upper limit of the computational load, the calculation of the total computational load of the reflected sounds extracted, and the comparison of the total computational load with the computational load upper limit.

Furthermore, the extraction of a reflected sound having a sound volume that is equal to or higher than the threshold value may be performed after the evaluation value is determined, or may be performed after it has been determined that the reflected sound is to be selected. For example, even if it has been determined that a reflected sound will be selected based on the evaluation value or the computational load, when the sound volume of the reflected sound is less than the threshold value, it may be re-determined that the reflected sound is not to be selected.

### Generation of Direct Sounds and Reflected Sounds

Next, in the generation processing of direct sounds and reflected sounds (S103 in FIG. 8), synthesizer 1303 generates and synthesizes the audio signals for direct sounds and the audio signals for reflected sounds that have been selected by selector 1302 as reflected sounds to be generated.

The audio signals for direct sounds are generated by applying the arrival time period (td) and the arrival time sound volume (ld) calculated by analyzer 1301 to the sound data for the sound source objects included in the input signal. Specifically, processing in which the sound data is delayed by the amount of the arrival time period (td) and multiplied by the arrival time sound volume (ld) is performed. The processing to delay the sound data is processing in which the position of the sound data is moved forward or backward on the time axis. Processing in which the sound data is delayed may be applied without causing the sound quality to deteriorate, such as was disclosed in PTL 2.

The audio signals for reflected sounds are, similarly to the direct sounds, generated by applying the arrival time period (tr) and the arrival time sound volume (lr) calculated by analyzer 1301 to the sound data for the sound source objects.

However, the arrival time sound volume (lr) in the generation of reflected sounds differs from the arrival time sound volume of the direct sounds in that the arrival time sound volume of the reflected sounds is a value to which attenuation rate G of the sound volume in the reflection has been applied. G may be an attenuation rate that is applied globally to all frequency bands. Alternatively, in order to reflect the biases of frequency components generated by reflection, the reflectance may be defined for each predetermined frequency band. In this case, the processing to apply the arrival time sound volume (lr) may be performed as frequency equalizer processing, which is processing that involves multiplying each band by the attenuation rate.

### Pipeline Processing

The above-described processing performed by analyzer 1301, selector 1302, and synthesizer 1303 may, for example, be performed as pipeline processing such as that described in PTL 3.

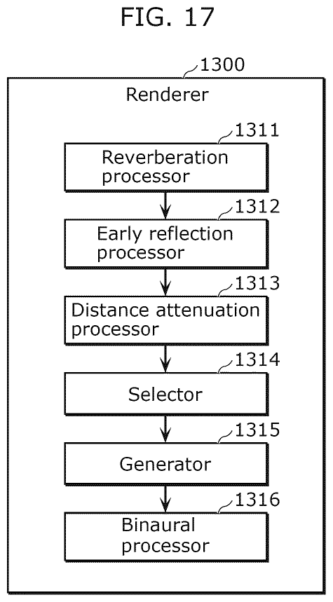

FIG. 17 is a block diagram for illustrating a configuration example for renderer 1300 to perform pipeline processing.

Renderer 1300 in FIG. 17 includes reverberation processor 1311, early reflection processor 1312, distance attenuation processor 1313, selector 1314, generator 1315, and binaural processor 1316. Reverberation processor 1311, early reflection processor 1312, and distance attenuation processor 1313 perform reverberation processing, early reflection processing, and distance attenuation processing, respectively. Selector 1314 selects reflected sounds, generator 1315 generates direct sounds and reflected sounds, and binaural processor 1316 applies binaural processing to the direct sounds and the reflected sounds.

These constituent elements may be configured as a plurality of the constituent elements of renderer 1300 illustrated in FIG. 7, or may be configured as at least a part of the plurality of constituent elements of audio signal processing device 1001 illustrated in FIG. 5.

Pipeline processing refers to dividing the processing for applying acoustic effects into a plurality of processes and executing each of the plurality of processes one by one in order. The plurality of processes include, for example, signal processing on the audio signal, generation of parameters used for signal processing, and the like.

Renderer 1300 may perform reverberation processing, early reflection processing, distance attenuation processing, binaural processing, and the like as pipeline processing. However, these types of processing are examples, and the pipeline processing may include processes other than these, or may not include a part of these processes. For example, the pipeline processing may include diffraction processing and occlusion processing. Furthermore, for example, the reverberation processing may be omitted when unneeded.

Furthermore, each process may be expressed as a stage. Moreover, the audio signals of the reflected sounds and the like generated as the result of the processes may be expressed as rendering items. The plurality of stages and the order of these stages in the pipeline processing are not limited to the example illustrated in FIG. 17.

Here, the parameters (the arrival paths and the arrival time periods pertaining to direct sounds and reflected sounds) used in the selection processing are calculated in one of the plurality of stages for generating the rendering items. In other words, the parameters used for selecting the reflected sounds are calculated as a part of the pipeline processing for generating the rendering items. Note that it is not necessary for all of the stages to be performed by renderer 1300. For example, a part of the stages may be omitted, or may be performed by an element other than renderer 1300.

The reverberation processing, the early reflection processing, the distance attenuation processing, the selection processing, the generation processing, and the binaural processing that may be included as stages in the pipeline processing will be described. In each stage, the metadata included in the input signal may be analyzed, and the parameters used for generating the reflected sounds may be calculated.

In the reverberation processing, reverberation processor 1311 generates an audio signal indicating reverberation sound or the parameters used in generating the audio signal. Reverberation sound is a sound that arrives at the listener as reverberation after the direct sound. As one example, the reverberation sound is a sound that arrives at the listener at a relatively late stage (for example, approximately 100 to 200 ms after the arrival of the direct sound) after the early reflected sound (to be described later) arrives at the listener, and after undergoing more reflections (for example, several tens of times) than the early reflected sound.

Reverberation processor 1311 refers to the audio signal and spatial information included in the input signal, and calculates reverberation sound by using, as a function for generating reverberation sound, a predetermined function prepared beforehand.

Reverberation processor 1311 may generate reverberation sound by applying a known reverberation generation method to the audio signal included in the input signal. One example of a known reverberation generation method is the Schroeder method, but the known reverberation generation method is not limited to the Schroeder method. Furthermore, reverberation processor 1311 uses the shape and an acoustic property of a sound reproduction space indicated by the spatial information when applying the known reverberation generation method. In this way, reverberation processor 1311 can calculate parameters for generating reverberation sound.

In the early reflection processing, early reflection processor 1312 calculates parameters for generating early reflection sounds based on the spatial information. The early reflected sound is reflected sound that arrives at the listener at a relatively early stage (for example, approximately several tens of ms after the arrival of the direct sound) after the direct sound from the sound source object arrives at the listener, and after undergoing one or more reflections.

Early reflection processor 1312 references, for example, the audio signal and metadata, and calculates the path, from reflection objects, of reflected sound that arrives at the listener after being reflected by the reflection objects. For example, in calculation of the path, the shape of the three-dimensional sound field (space), the size of the three-dimensional sound field, the positions of reflection objects such as structures, the reflectance of reflection objects, and the like may be used.

Early reflection processor 1312 may calculate the path of the direct sound. The information of said path may be used as a parameter for early reflection processor 1312 to generate the early reflected sound, and may be used as a parameter for selector 1314 to select reflected sounds.

In the distance attenuation processing, distance attenuation processor 1313 calculates the sound volume of the direct sound and the reflected sound that arrive at the listener, based on the lengths of the paths of the direct sound and the reflected sound. The sound volume of the direct sound and the reflected sound that arrive at the listener attenuate, with respect to the sound volume of the sound source, in proportion to the distance of the path to the listener (in inverse proportion to the distance). Thus, distance attenuation processor 1313 is able to calculate the sound volume of the direct sound by dividing the sound volume of the sound source by the length of the path of the direct sound, and is able to calculate the sound volume of the reflected sound by dividing the sound volume of the sound source by the length of the path of the reflected sound.

In the selection processing, selector 1314 selects the reflected sounds to be generated, based on the parameters calculated before the selection processing. One of the selection methods of the present disclosure may be used for selection of the reflected sounds to be generated.

Furthermore, when the selection processing is included in the pipeline processing, the reflected sounds not selected in the selection processing need not be subjected to processing after the selection processing in the pipeline processing. Not subjecting the reflected sounds that were not selected to the processing after the selection processing makes it possible to reduce the computational load on audio signal processing device 1001, in comparison to when omitting only the binaural processing.

Furthermore, when the selection processing is included in the pipeline processing, assigning the selection processing an earlier order among the plurality of processes in the pipeline processing makes it possible to omit a greater number of processes, whereby the amount of computation can be further reduced.

In the binaural processing, binaural processor 1316 performs signal processing so that the audio signal of the direct sound is perceived as sound arriving at the listener from the direction of the sound source object. Furthermore, binaural processor 1316 performs signal processing so that the reflected sounds selected by selector 1314 are perceived as sounds arriving at the listener from the reflection object.

For example, based on the position and orientation of the listener in the sound space, binaural processor 1316 performs processing to apply an HRIR DB so that sound arrives at the listener from the position of the sound source object or the position of the obstacle object.

Note that HRIR (Head-Related Impulse Responses) is the response characteristic when one impulse is generated. Specifically, HRIR is the response characteristic obtained by converting from an expression in the frequency domain to an expression in the time domain by Fourier transforming the head-related transfer function, in which the change in sound caused by surrounding objects including the auricle, the head, and the shoulders is expressed as a transfer function. The HRIR DB is a database including such information.

Furthermore, the position and orientation of the listener in the sound space are, for example, the position and orientation of a virtual listener in a virtual sound space. The position and orientation of the virtual listener in the virtual sound space may change in accordance with movement of the head of the listener. Furthermore, the position and orientation of the virtual listener in the virtual sound space may be determined based on information obtained from sensor 1405.

The program(s), spatial information, HRIR DB, threshold value data, other parameters, and/or the like used in the above-described processing are obtained from memory 1404 included in audio signal processing device 1001, or from outside of audio signal processing device 1001.

Furthermore, the pipeline processing may contain other processes. Moreover, renderer 1300 may contain a processor that is not illustrated, for performing another process included in the pipeline processing. For example, renderer 1300 may include a diffraction processor and an occlusion processor.

The diffraction processor executes processing to generate an audio signal indicating sound including diffracted sound caused by an obstacle object between the listener and the sound source object in a three-dimensional sound field (space). Diffracted sound is sound that, when an obstacle object is present between the sound source object and the listener, arrives at the listener from the sound source object by going around the obstacle object.

The diffraction processor references, for example, the audio signal and metadata, and calculates the path by which diffracted sound arrives at the listener from the sound source object by detouring around the obstacle object, and generates diffracted sound based on the calculated path. In the calculation of the path, the sound source object in the three-dimensional sound field (space), the positions of the listener and the obstacle object, the shape and size of the obstacle object, and the like may be used.

When a sound source object is present on the other side of an obstacle object, the occlusion processor generates an audio signal for a sound that passes from the sound source object through the obstacle object and is audible therethrough, based on spatial information and information on the material, etc. of the obstacle object.

### Sound Source Object Example

As described above, in the position information assigned to the sound source object, a “point” in the virtual space indicates the position of a sound source object. In other words, as described above, the sound source is defined as a “point sound source”.

On the other hand, a sound source in a virtual space may be defined as an object that has a length, size, shape, and the like, i.e., as a sound source that is not a point sound source, but a spatially extended sound source. In this case, the distance between the listener and the sound source, and the direction of arrival of the sound are not determined. Consequently, reflected sounds originating from such a sound source may be limited to being selected by selector 1302 without performing analysis by analyzer 1301, or regardless of the analysis result. By doing so, it is possible to avoid the sound quality degradation that might occur by not selecting the reflected sound.

Alternatively, a representative point such as the center of gravity of the object may be determined, and the processing of the present disclosure may be applied on the assumption that sound is generated from that representative point. In this case, the threshold value may be adjusted in accordance with information on the spatial extension of the sound source.

### Examples of Direct Sound and Reflected Sound

For example, direct sound is sound that has not been reflected by a reflection object, and reflected sound is sound that has been reflected by a reflection object. Direct sound may be sound that has arrived at the listener from a sound source without being reflected by a reflection objection, and reflected sound may be sound that has arrived at the listener from a sound source due to being reflected by a reflection object.

Furthermore, each of direct sound and reflected sound are not limited to being sound that has arrived at the listener, and may each be sound that will arrive at the listener. For example, direct sound may be sound that has been outputted from a sound source, or to put it differently, a sound source sound.

### Example Structure of Bitstream

The bitstream includes, for example, an audio signal and metadata. The audio signal is sound data in which sound is expressed, and indicates, e.g., information on the frequency and intensity of sound. Furthermore, metadata includes spatial information on the sound space, which is the space of the sound field.

For example, the spatial information is information on the space in which the listener who hears sound based on the audio signal is positioned. Specifically, the spatial information is information about a predetermined position (localization position) in the sound space (for example, a three-dimensional sound field) for localizing the sound image of the sound at that predetermined position, that is, for causing the listener to perceive the sound as arriving from a direction that corresponds to the predetermined position. The spatial information includes, for example, sound source object information and position information indicating the position of the listener.

The sound source object information is information on a sound source object that generates sound based on the audio signal. In other words, the sound source object information is information on an object (a sound source object) that reproduces the audio signal, and is information on a virtual sound source object located in a virtual sound space. Here, the virtual sound space may correspond to real-world space in which an object that generates sound is located, and the sound source object in the virtual sound space may correspond to an object that generates sound in a real-world space.

The sound source object information may indicate, for example, the position of the sound source object located in the sound space, the orientation of the sound source object, the directivity of the sound emitted by the sound source object, whether the sound source object belongs to an animate thing, whether the sound source object is a mobile body, and the like. For example, the audio signal is associated with one or more sound source objects indicated by the sound source object information.

The bitstream includes, for example, metadata (control information) and an audio signal.

The audio signal and metadata may be contained in a single bitstream or may be separately contained in a plurality of bitstreams. Furthermore, the audio signal and metadata may be contained in a single file or may be separately contained in a plurality of files.

The bitstream may exist for each sound source or may exist for each playback time. Even in a case in which bitstreams exist for each playback time, a plurality of bitstreams may be processed in parallel simultaneously.

Metadata may be assigned to each bitstream, or may be collectively assigned to a plurality of bitstreams as information for controlling the plurality of bitstreams. In this case, the plurality of bitstreams may share the metadata. Furthermore, the metadata may be assigned for each playback time.

When a plurality of bitstreams or a plurality of files exist, information indicating a relevant bitstream or a relevant file may be contained in one or more bitstreams or one or more files. Alternatively, information indicating a relevant bitstream or a relevant file may be contained in each of all of the bitstreams or each of all of the files.

Here, the relevant bitstream or the relevant file is, for example, a bitstream or file that may be used simultaneously during acoustic processing. Furthermore, a bitstream or file that collectively describes the information indicating the relevant bitstream or the relevant file may be included.

Here, the information indicating the relevant bitstream or the relevant file may be, for example, an identifier indicating a relevant bitstream or a relevant file. Furthermore, the information indicating the relevant bitstream or the relevant file may be, for example, a file name indicating a relevant bitstream or a relevant file, a uniform resource locator (URL), a uniform resource identifier (URI), or the like.

In this case, an obtainer identifies and obtains a relevant bitstream or a relevant file based on the information indicating the relevant bitstream or the relevant file. Furthermore, the information indicating the relevant bitstream or the relevant file may be included in a bitstream or a file, and the information indicating the relevant bitstream or the relevant file may be included in a different bitstream or a different file.

Here, the file including the information indicating the relevant bitstream or the relevant file may be, for example, a control file such as a manifest file used in content distribution.

Note that the entire metadata or part of the metadata may be obtained from somewhere other than a bitstream of the audio signal. For example, either one of metadata for controlling an acoustic sound or metadata for controlling a video may be obtained from somewhere other than from a bitstream, or both may be obtained from somewhere other than from a bitstream.

Furthermore, the metadata for controlling a video may be included in the bitstream obtained by three-dimensional sound reproduction system 1000. In this case, three-dimensional sound reproduction system 1000 may output the metadata for controlling a video to a display device that displays images or a stereoscopic video reproduction device that reproduces stereoscopic videos.

### Examples of Information Included in Metadata

The metadata may be information used for describing a scene expressed in the sound space. As used herein, the term “scene” refers to a collection of all elements that represent three-dimensional video and acoustic events in the sound space, which are modeled in three-dimensional sound reproduction system 1000 using metadata.

Thus, the metadata may include not only information for controlling acoustic processing, but also information for controlling video processing. The metadata may include only one among the information for controlling acoustic processing or the information for controlling video processing, or may include both.

Three-dimensional sound reproduction system 1000 generates virtual acoustic effects by performing acoustic processing on the audio signal using the metadata included in the bitstream and additionally obtained interactive listener position information. Early reflection processing, obstacle processing, diffraction processing, occlusion processing, and reverberation processing may be performed as acoustic effects, and other acoustic processing may be performed using the metadata. For example, an acoustic effect such as a distance decay effect, localization, or a Doppler effect may be added.

In addition, information for switching between on and off of all or one or more of the acoustic effects, and priority information pertaining to a plurality of processes for the acoustic effects may be added to the metadata.

As an example, the metadata includes information about a sound space including a sound source object and an obstacle object and information about a localization position for localizing the sound image at a predetermined position in the sound space (that is, causing the listener to perceive the sound as arriving from a predetermined direction).

Here, an obstacle object is an object that can influence a sound emitted by a sound source object and perceived by the listener, by, for example, blocking or reflecting the sound between the sound source object and the listener. The obstacle object can include an animal or a movable body such as a machine, in addition to a stationary object. The animal may be a person or the like.

Furthermore, when a plurality of sound source objects are present in a sound space, another sound source object may be an obstacle object for a certain sound source object. In other words, non-sound-emitting objects such as building materials or inanimate objects, and sound source objects that emit sound can both be obstacle objects.

The metadata includes information indicating all or part of the shape of the sound space, the shapes and positions of obstacle objects in the sound space, the shapes and positions of sound source objects in the sound space, and the position and orientation of the listener in the sound space.

The sound space may be either a closed space or an open space. Furthermore, the metadata may include information indicating the reflectance of each obstacle object that can reflect sound in the sound space. For example, the floor, walls, ceiling, and the like constituting the boundaries of the sound space can be included in the obstacle objects.

The reflectance is an energy ratio between a reflected sound and an incident sound, and may be set for each sound frequency band. Of course, the reflectance may be uniformly set, irrespective of the sound frequency band. Note that when the sound space is an open space, for example, parameters such as a uniformly set attenuation rate, diffracted sound, and early reflected sound may be used.

The metadata may include information other than reflectance as a parameter with regard to an obstacle object or a sound source object. For example, the metadata may include information on the material of an object as a parameter related to both of a sound source object and a non-sound-emitting object. Specifically, the metadata may include information such as diffusivity, transmittance, and sound absorption rate.

For example, information on a sound source object may include information indicating, for example, sound volume, a radiation property (directivity), a reproduction condition, the number and types of sound sources of one object, and a sound source region of an object. The reproduction condition may determine whether a sound is, for example, a sound that is continuously being emitted or is emitted at an event. The sound source region of an object may be determined by the relative relationship between the position of the listener and the position of the object, or may be determined using the object as a reference.

For example, when the sound source region is determined by the relative relationship between the position of the listener and the position of the object, it is possible to cause the listener to perceive sound A from the right side of the object and sound B from the left side of the object, the right side and the left side being as seen from the listener.

Furthermore, when the sound source region is determined using the object as a reference, it is possible to fix what sound is emitted from what region of the object, using the object as a reference. For example, it is possible, when the listener sees the object from the front, to cause the listener to perceive a high sound from the right side of the object and a low sound from the left side of the object. Furthermore, it is possible, when the listener sees the object from the rear, to cause the listener to perceive a low sound from the right side of the object and a high sound from the left side of the object.

Metadata related to the space may include the time period until early reflected sound, the reverberation time period, the ratio of direct sound to diffuse sound, and the like. When the ratio between a direct sound and a diffuse sound is zero, the listener can be caused to perceive only the direct sound.

### Supplement

Note that the aspects understood based on the present disclosure are not limited to the embodiment, and various changes may be performed.

For example, a process performed by a certain constituent element in the embodiment may be performed by another constituent element instead of the specific constituent element. Furthermore, the order of a plurality of processes may be changed, or a plurality of processes may be performed in parallel.

Moreover, ordinals such as first and second used for description may be interchanged, removed, or newly assigned as appropriate. These ordinals do not necessarily correspond to meaningful orders, and may be used to distinguish between elements.

Furthermore, for example, in comparisons between threshold values, “greater than or equal to” a threshold value and “greater than” a threshold value may be read interchangeably. Similarly, “less than or equal to” a threshold value and “less than” a threshold value may be read interchangeably. Moreover, for example, there may be cases in which the terms “time period” and “time” are read interchangeably.

Furthermore, in a process for selecting one or more sounds to be processed from a plurality of sounds, no sounds need be selected as a sound to be processed if no sounds that satisfy the conditions exist. In other words, a case in which no sounds to be processed are selected may be included in the process for selecting one or more sounds to be processed from a plurality of sounds.

Furthermore, at least one of a first element, a second element, or a third element can correspond to the first element, the second element, or any combination of these.

In addition, for example, in the embodiment, the case in which the aspects that are understood based on the present disclosure are implemented as an acoustic processing device, an encoding device, or a decoding device has been described. However, the aspects that are understood based on the present disclosure are not limited thereto, and may be implemented as software for executing the acoustic processing method, the encoding method, or the decoding method.

For example, a program for executing the above-described acoustic processing method, encoding method, or decoding method may be stored beforehand in ROM. Then, a CPU may operate according to this program.

Furthermore, a program for executing the above-described acoustic processing method, encoding method, or decoding method may be stored on a computer-readable recording medium. Then, a computer may record, in computer RAM, the program stored on the recording medium, and operate according to this program.

Moreover, each of the above-described constituent elements may be expressed typically as a large-scale integration (LSI), which is an integrated circuit (IC) having an input terminal and an output terminal. These may take the form of individual chips, or all or one or more constituent elements of the embodiment may be encapsulated in a single chip. Depending upon the level of integration, the LSI may be expressed as an IC, a system LSI, a super LSI, or an ultra LSI.

Furthermore, such IC is not limited to an LSI, and a dedicated circuit or a general-purpose processor may be used. Alternatively, a field programmable gate array (FPGA) that allows for programming after the manufacture of an LSI, or a reconfigurable processor that allows for reconfiguration of the connection and the setting of circuit cells inside an LSI may be employed. Furthermore, when a circuit integration technology that replaces LSIs comes along owing to advances in semiconductor technology or to a separate derivative technology, the constituent elements should naturally be integrated using that technology. The adaptation of biotechnology, and the like are also conceivable as possibilities.

Moreover, an FPGA, a CPU, or the like may, by means of wireless communication or wired communication, download all or a part of the software for executing the acoustic processing method, the encoding method, or the decoding method described in the present disclosure. Furthermore, all or a part of software for updating may be downloaded by means of wireless communication or wired communication. Moreover, an FPGA, a CPU, or the like may execute the digital signal processing described in the present disclosure by storing the downloaded software in memory and operating based on the stored software.

At this time, the machine that includes the FPGA, the CPU, or the like may be connected wirelessly or in a wired manner to a signal processing device, or may be connected to a signal processing server over a network. Accordingly, this machine and the signal processing device or the signal processing server may perform the acoustic processing method, the encoding method, or the decoding method described in the present disclosure.

For example, the acoustic processing device, the encoding device, or the decoding device in the present disclosure may include an FPGA, a CPU, or the like. Furthermore, the acoustic processing device, the encoding device, or the decoding device may include: an interface for acquiring, from an external source, the software for causing the FPGA, the CPU, or the like to operate; and memory for storing the acquired software. The FPGA, the CPU, or the like may perform the signal processing described in the present disclosure by operating based on the stored software.

A server may provide the software related to the acoustic processing, the encoding processing, or the decoding processing of the present disclosure. Furthermore, a terminal or a machine may operate as the acoustic processing device, the encoding device, or the decoding device described in the present disclosure by installing the software. Note that the terminal or the machine may install the software by connecting to a server over a network.

Furthermore, the software may be installed on the terminal or the machine by means of another device that is different from the terminal or the machine obtaining data for installing the software by connecting to a server over a network and providing the data for installing the software to the terminal or the machine. Note that VR software or AR software for causing a terminal or a machine to execute the acoustic processing method described by way of the embodiment may be an example of the software.

Note that in the foregoing embodiment, each constituent element may be configured from dedicated hardware, or may be implemented by executing a software program suitable for each constituent element. Each constituent element may be implemented by means of a program executor such as a CPU or a processor loading and executing a software program recorded on a recording medium such as a hard disk or semiconductor memory.

Thus, the device and the like according to one or more aspects have been described by way of the embodiment, but the aspects understood based on the present disclosure are not limited to the embodiment. The one or more aspects may thus include forms obtained by making various modifications to the above embodiments that can be conceived by those skilled in the art, as well as forms obtained by combining constituent elements in different variations, without materially departing from the spirit of the present disclosure.

### Addendum

The following techniques are disclosed by the description of the foregoing embodiment.

### Technique 1

An acoustic processing device includes: a circuit; and a memory, wherein using the memory, the circuit: obtains sound space information, the sound space information including information on a sound source in a sound space, information on an object in the sound space, and information on a position of a listener in the sound space; and calculates, using the sound space information, an evaluation value of a reflected sound generated in response to a sound generated from the sound source.

### Technique 2

The acoustic processing device according to technique 1, wherein the circuit controls whether to select the reflected sound, based on the evaluation value.

### Technique 3

The acoustic processing device according to technique 2, wherein when the reflected sound is not selected, the circuit skips binaural processing on the reflected sound.

### Technique 4

The acoustic processing device according to any one of techniques 1 to 3, wherein the circuit: calculates a sound volume of the reflected sound; and calculates the evaluation value when the sound volume exceeds a predetermined threshold value.

### Technique 5

The acoustic processing device according to technique 2, wherein when the reflected sound is selected based on the evaluation value, the circuit: calculates a total computational load of one or more selected reflected sounds including the reflected sound; and skips selecting the reflected sound when the total computational load exceeds a predetermined upper limit.

### Technique 6

The acoustic processing device according to technique 5, wherein the total computational load is specified by a total number of the one or more selected reflected sounds or by an amount of processing required for the one or more selected reflected sounds.

### Technique 7

The acoustic processing device according to any one of techniques 1 to 6, wherein the circuit: calculates, for each of a plurality of reflected sounds generated as the reflected sound in the sound space, a sound volume of the reflected sound; and calculates, for each of one or more reflected sounds of the plurality of reflected sounds that has a sound volume greater than or equal to a predetermined threshold value, the evaluation value of the reflected sound.

### Technique 8

The acoustic processing device according to technique 7, wherein the circuit: calculates a total computational load of the one or more reflected sounds; and calculates, for each of the one or more reflected sounds, the evaluation value of the reflected sound, when the total computational load exceeds a predetermined upper limit.

### Technique 9

The acoustic processing device according to any one of techniques 1 to 8, wherein the circuit: calculates, for each of a plurality of reflected sounds generated as the reflected sound in the sound space, the evaluation value of the reflected sound; adds, for each of the plurality of reflected sounds in descending order of the evaluation value, a computational load of the reflected sound to a total computational load; compares the total computational load to a predetermined upper limit each time the computational load of the reflected sound is added to the total computational load; selects the reflected sound when the total computational load obtained by adding the computational load of the reflected sound does not exceed the predetermined upper limit; and skips selecting remaining one or more reflected sounds among the plurality of reflected sounds when the total computational load obtained by adding the computational load of the reflected sound exceeds the predetermined upper limit, the remaining one or more reflected sounds being the reflected sound and after.

### Technique 10

The acoustic processing device according to any one of techniques 1 to 9, wherein the evaluation value is a total value of one or more indicator values among an indicator value regarding sound volume, a visual indicator value, an indicator value regarding the object, and an indicator value indicating a relationship between a direct sound corresponding to the reflected sound and the reflected sound.

### Technique 11

The acoustic processing device according to technique 10, wherein the circuit sets the indicator value regarding sound volume to be greater as a sound volume of the sound generated from the sound source is greater.

### Technique 12

The acoustic processing device according to technique 10 or 11, wherein when the sound source is in a visual field of the listener, the circuit increases the visual indicator value to be greater than when the sound source is not in the visual field of the listener.

### Technique 13

The acoustic processing device according to any one of techniques 10 to 12, wherein the circuit sets the visual indicator value to be greater as a moving speed of the sound source is slower.

### Technique 14

The acoustic processing device according to any one of techniques 10 to 13, wherein the indicator value regarding the object is assigned per object in the sound space and is included in the sound space information.

### Technique 15

The acoustic processing device according to any one of techniques 10 to 14, wherein the circuit sets the indicator value indicating the relationship between the direct sound and the reflected sound to be greater as an angle formed by a direction of arrival of the direct sound and a direction of arrival of the reflected sound is larger.

### Technique 16

The acoustic processing device according to any one of techniques 10 to 15, wherein the circuit sets the indicator value indicating the relationship between the direct sound and the reflected sound to be greater as a difference between a distance the direct sound travels from the sound source to arrive at the listener and a distance the reflected sound travels from the sound source to arrive at the listener after being reflected is greater.

### Technique 17

The acoustic processing device according to any one of techniques 10 to 16, wherein the circuit sets the indicator value indicating the relationship between the direct sound and the reflected sound to be greater as an amplitude value of the reflected sound further exceeds a temporal masking threshold value, the temporal masking threshold value being a threshold value of a temporal masking phenomenon in which the reflected sound is masked by the direct sound when the amplitude value of the reflected sound is less than or equal to the threshold value.

### Technique 18

The acoustic processing device according to any one of techniques 10 to 17, wherein the circuit: repeats processing that includes: reducing the indicator value regarding the object regarding a reflected sound that has been selected from a plurality of reflected sounds each generated as the reflected sound in the sound space; calculating the evaluation value for each of the plurality of reflected sounds that have not been selected; and selecting, in descending order of the evaluation value, a reflected sound from the plurality of reflected sounds that have not been selected; and ends the processing that is repeated, when a total computational load of one or more reflected sounds selected from the plurality of reflected sounds exceeds a predetermined upper limit.

### Technique 19

An acoustic processing device including: a circuit; and a memory, wherein using the memory, the circuit: obtains information on a sound volume of a sound outputted from a sound source; corrects an evaluation value of a reflected sound corresponding to the sound, by using information on the sound volume; and controls whether to select the reflected sound, based on the evaluation value corrected.

### Technique 20

The acoustic processing device according to technique 19, wherein the sound volume has a transition.

### Technique 21

An acoustic processing method including: obtaining sound space information, the sound space information including information on a sound source in a sound space, information on an object in the sound space, and information on a position of a listener in the sound space; and calculating, using the sound space information, an evaluation value of a reflected sound generated in response to a sound generated from the sound source.

### Technique 22

A program for causing a computer to execute the acoustic processing method according to technique 21.

### INDUSTRIAL APPLICABILITY

The present disclosure includes aspects that can be applied to the acoustic processing device, the encoding device, the decoding device, or a terminal or a machine that includes any of these.

1. An acoustic processing device comprising:
a circuit; and
a memory, wherein
using the memory, the circuit:
obtains sound space information, the sound space information including information on a sound source in a sound space, information on an object in the sound space, and information on a position of a listener in the sound space; and
calculates, using the sound space information, an evaluation value of a reflected sound generated in response to a sound generated from the sound source.

2. The acoustic processing device according to claim 1, wherein
the circuit controls whether to select the reflected sound, based on the evaluation value.

3. The acoustic processing device according to claim 2, wherein
when the reflected sound is not selected, the circuit skips binaural processing on the reflected sound.

4. The acoustic processing device according to claim 1, wherein
the circuit:
calculates a sound volume of the reflected sound; and
calculates the evaluation value when the sound volume exceeds a predetermined threshold value.

5. The acoustic processing device according to claim 2, wherein
when the reflected sound is selected based on the evaluation value, the circuit:
calculates a total computational load of one or more selected reflected sounds including the reflected sound; and
skips selecting the reflected sound when the total computational load exceeds a predetermined upper limit.

6. The acoustic processing device according to claim 5, wherein
the total computational load is specified by a total number of the one or more selected reflected sounds or by an amount of processing required for the one or more selected reflected sounds.

7. The acoustic processing device according to claim 1, wherein
the circuit:
calculates, for each of a plurality of reflected sounds generated as the reflected sound in the sound space, a sound volume of the reflected sound; and
calculates, for each of one or more reflected sounds of the plurality of reflected sounds that has a sound volume greater than or equal to a predetermined threshold value, the evaluation value of the reflected sound.

8. The acoustic processing device according to claim 7, wherein
the circuit:
calculates a total computational load of the one or more reflected sounds; and
calculates, for each of the one or more reflected sounds, the evaluation value of the reflected sound, when the total computational load exceeds a predetermined upper limit.

9. The acoustic processing device according to claim 1, wherein
the evaluation value is a total value of one or more indicator values among an indicator value regarding sound volume, a visual indicator value, an indicator value regarding the object, and an indicator value indicating a relationship between a direct sound corresponding to the reflected sound and the reflected sound.

10. The acoustic processing device according to claim 9, wherein
the circuit sets the indicator value regarding sound volume to be greater as a sound volume of the sound generated from the sound source is greater.

11. The acoustic processing device according to claim 9, wherein
when the sound source is in a visual field of the listener, the circuit increases the visual indicator value to be greater than when the sound source is not in the visual field of the listener.

12. The acoustic processing device according to claim 9, wherein
the circuit sets the visual indicator value to be greater as a moving speed of the sound source is slower.

13. The acoustic processing device according to claim 9, wherein
the indicator value regarding the object is assigned per object in the sound space and is included in the sound space information.

14. The acoustic processing device according to claim 9, wherein
the circuit sets the indicator value indicating the relationship between the direct sound and the reflected sound to be greater as an angle formed by a direction of arrival of the direct sound and a direction of arrival of the reflected sound is larger.

15. The acoustic processing device according to claim 9, wherein
the circuit sets the indicator value indicating the relationship between the direct sound and the reflected sound to be greater as a difference between a distance the direct sound travels from the sound source to arrive at the listener and a distance the reflected sound travels from the sound source to arrive at the listener after being reflected is greater.

16. The acoustic processing device according to claim 9, wherein
the circuit sets the indicator value indicating the relationship between the direct sound and the reflected sound to be greater as an amplitude value of the reflected sound further exceeds a temporal masking threshold value, the temporal masking threshold value being a threshold value of a temporal masking phenomenon in which the reflected sound is masked by the direct sound when the amplitude value of the reflected sound is less than or equal to the threshold value.

17. An acoustic processing device comprising:
a circuit; and
a memory, wherein
using the memory, the circuit:
obtains information on a sound volume of a sound outputted from a sound source;
corrects an evaluation value of a reflected sound corresponding to the sound, by using information on the sound volume; and
controls whether to select the reflected sound, based on the evaluation value corrected.

18. The acoustic processing device according to claim 17, wherein
the sound volume has a transition.

19. An acoustic processing method comprising:
obtaining sound space information, the sound space information including information on a sound source in a sound space, information on an object in the sound space, and information on a position of a listener in the sound space; and
calculating, using the sound space information, an evaluation value of a reflected sound generated in response to a sound generated from the sound source.

20. A non-transitory computer-readable recording medium having recorded thereon a program for causing a computer to execute the acoustic processing method according to claim 19.
